(19) United States
(12) Patent Application Publication
(10) Pub. No.: US 2025/0037590 A1
(43) Pub. Date: Jan. 30, 2025

(54) CONTROL DEVICE, DRONE, CONTROL METHOD, AND RECORDING MEDIUM

(71) Applicant: NEC Corporation, Minato-ku, Tokyo (JP)

(72) Inventors: Remi TANAKA, Tokyo (JP); Takeshi SHOUTA, Tokyo (JP); Hiroyuki KAKINUMA, Tokyo (JP); Tomoyuki MUTO, Tokyo (JP)

(73) Assignee: NEC Corporation, Minato-ku, Tokyo (JP)

(21) Appl. No.: 18/714,139

(22) PCT Filed: Dec. 16, 2021
(86) PCT No.: PCT/JP2021/046451

§ 371 Date: May 29, 2024

(51) Int. Cl. G08G 5/00; B64U 20/87; B64U 50/20; G05D 1/46

(52) U.S. Cl. CPC G08G 5/0069; B64U 20/87; B64U 50/20; G05D 1/46

(57) ABSTRACT

A control device that includes a sensing unit that detects, from an image captured by a camera mounted in a drone, a guide light to be used for forming a corridor used by the drone, and identifies a position of the detected guide light, a calculation unit that calculates, according to positions of the drone and the guide light, a predicted arrival position of the drone and a control target position according to a positional relationship between the drone and the guide light at a control timing subsequent to a timing of capturing the image, a control condition generation unit that generates a control condition for a motor that drives a propeller of the drone according to the predicted arrival position and the control target position, and a control condition setting unit that sets the control condition for the motors of the drone.

### TECHNICAL FIELD

The present disclosure relates to a control device or the like that controls a drone that uses an airspace dedicated to the drone.

### BACKGROUND ART

There is an increasing need to operate drones in densely populated areas such as urban areas. In order to ensure safe and stable operation, maintenance of an airspace (also referred to as corridors) maintained in such a way that drones can fly safely has been studied.

PTL 1 discloses a navigation system of a drone. PTL 1 discloses a drone highway configured to navigate a drone using existing infrastructure such as power lines, roads, and pipelines. In the method of PTL 1, the drone collects environmental data related to the heat of the infrastructure and the spectrum such as infrared rays and visible light. The drone compares the collected environmental data with data signatures associated with the drone highway to determine its location on that drone highway.

PTL 2 discloses a lighting system of a mobile body in which a front portion facing a traveling direction is configured to be selectable from a plurality of places. The system of PTL 2 includes a plurality of light units capable of changing colors of lights, and a control unit that controls the plurality of light units based on a traveling direction of a mobile body. In a case where the mobile body is an unmanned aerial vehicle, the control unit controls the plurality of light units in such a way as to cause the light unit located at the right end of the unmanned aerial vehicle to emit light of a first color and cause the light unit located at the left end of the unmanned aerial vehicle to emit light of a second color.

### CITATION LIST

### Patent Literature

PTL 1: JP 2020-513122 A
PTL 2: JP 2020-093763 A

### SUMMARY OF INVENTION

### Technical Problem

According to the method of PTL 1, it is possible to navigate a drone over a long distance by controlling navigation of the drone according to the position of the drone on the drone highway. In PTL 1, it is not assumed that a plurality of drones simultaneously uses the same drone highway. For example, when a plurality of drones uses the same drone highway at the same time, the drones may be off the drone highway depending on the positional relationship between the drones.

According to the method of PTL 2, even when the front portion of the unmanned aerial vehicle is changed, the traveling direction of the unmanned aerial vehicle can be identified according to the combination of the colors of the lights. In the method of PTL 2, for example, when the entire unmanned aerial vehicle can be visually recognized, the traveling direction of the unmanned aerial vehicle can be identified. However, in the method of PTL 2, in a case where only part of the unmanned aerial vehicle can be confirmed, there is a possibility that the traveling direction of the unmanned aerial vehicle cannot be identified. Therefore, in the method of PTL 2, in a case where a plurality of unmanned aerial vehicles simultaneously uses the same corridor, there is a possibility that safe navigation cannot be continued unless the plurality of unmanned aerial vehicles can confirm each other's lights.

An object of the present disclosure is to provide a control device and the like capable of achieving autonomous navigation of a drone using a corridor.

### Solution to Problem

A control device according to an aspect of the present disclosure includes a sensing unit that detects, from an image captured by a camera mounted in a drone, a guide light to be used for forming a corridor used by the drone, and identifies a position of the detected guide light, a calculation unit that calculates, according to positions of the drone and the guide light, a predicted arrival position of the drone and a control target position according to a positional relationship between the drone and the guide light at a control timing subsequent to a timing of capturing the image, a control condition generation unit that generates a control condition for a motor that drives a propeller of the drone according to the predicted arrival position and the control target position, and a control condition setting unit that sets the control condition for the motors of the drone.

In a control method according to an aspect of the present disclosure, the method includes: detecting, from an image captured by a camera mounted in a drone, a guide light to be used for forming a corridor used by the drone and identifying a position of the detected guide light, calculating, according to positions of the drone and the guide light, a predicted arrival position of the drone and a control target position according to a positional relationship between the drone and the guide light at a control timing subsequent to a timing of capturing the image, generating a control condition for a motor that drives a propeller of the drone according to the predicted arrival position and the control target position, and setting the control condition for the motors of the drone.

A program according to an aspect of the present disclosure causes a computer to execute the steps comprising detecting, from an image captured by a camera mounted in a drone, a guide light to be used for forming a corridor used by the drone and identifying a position of the detected guide light, calculating, according to positions of the drone and the guide light, a predicted arrival position of the drone and a control target position according to a positional relationship between the drone and the guide light at a control timing subsequent to a timing of capturing the image, generating a control condition for a motor that drives a propeller of the drone according to the predicted arrival position and the control target position, and setting the control condition for the motors of the drone.

### Advantageous Effects of Invention

According to the present disclosure, it is possible to provide a control device and the like capable of achieving autonomous navigation of a drone using a corridor.

### BRIEF DESCRIPTION OF DRAWINGS

FIG. 1 is a block diagram illustrating an example of a configuration of a drone according to a first example embodiment.

FIG. 2 is a conceptual diagram illustrating an example of an appearance of a drone according to the first example embodiment.

FIG. 3 is a conceptual diagram illustrating another example of the appearance of the drone according to the first example embodiment.

FIG. 4 is a conceptual diagram illustrating an example of a corridor used by the drone according to the first example embodiment.

FIG. 5 is a conceptual diagram illustrating an example of a corridor used by the drone according to the first example embodiment.

FIG. 6 is a block diagram illustrating an example of a configuration of a control unit included in the drone according to the first example embodiment.

FIG. 7 is a conceptual diagram for describing a control example of the drone according to the first example embodiment.

FIG. 8 is a conceptual diagram for describing a control example of the drone according to the first example embodiment.

FIG. 9 is a conceptual diagram for describing a control example of the drone according to the first example embodiment.

FIG. 10 is a conceptual diagram illustrating an example of a corridor used by the drone according to the first example embodiment.

FIG. 11 is a conceptual diagram illustrating an example of a corridor used by the drone according to the first example embodiment.

FIG. 12 is a flowchart for describing an example of an operation of a control unit included in the drone according to the first example embodiment.

FIG. 13 is a block diagram illustrating an example of a configuration of a drone according to a second example embodiment.

FIG. 14 is a block diagram illustrating an example of a configuration of a control unit included in a drone according to the second example embodiment.

FIG. 15 is a conceptual diagram for describing a control example of the drone according to the second example embodiment.

FIG. 16 is a conceptual diagram for describing a control example of the drone according to the second example embodiment.

FIG. 17 is a flowchart for describing an example of the operation of the control unit included in the drone according to the second example embodiment.

FIG. 18 is a block diagram illustrating an example of a configuration of a drone according to a third example embodiment.

FIG. 19 is a block diagram illustrating an example of a configuration of a control unit included in a drone according to the third example embodiment.

FIG. 20 is a conceptual diagram for describing a control example of a drone according to the third example embodiment.

FIG. 21 is a conceptual diagram for describing a control example of a drone according to the third example embodiment.

FIG. 22 is a flowchart for describing an example of the operation of the control unit included in the drone according to the third example embodiment.

FIG. 23 is a block diagram illustrating an example of a configuration of a drone according to a fourth example embodiment.

FIG. 24 is a conceptual diagram illustrating an example of an appearance of a drone according to the fourth example embodiment.

FIG. 25 is a block diagram illustrating an example of a configuration of a control unit included in a drone according to the fourth example embodiment.

FIG. 26 is a conceptual diagram for describing a control example of the drone according to the fourth example embodiment.

FIG. 27 is a flowchart for describing an example of the operation of the control unit included in the drone according to the fourth example embodiment.

FIG. 28 is a block diagram illustrating an example of a configuration of a management device according to a fifth example embodiment.

FIG. 29 is a block diagram illustrating an example of a configuration of a drone that uses a corridor to be managed by a management device according to the fifth example embodiment.

FIG. 30 is a block diagram illustrating an example of a configuration of a control unit included in a drone that uses a corridor to be managed by a management device according to the fifth example embodiment.

FIG. 31 is a conceptual diagram for describing a guidance example of a drone according to the fifth example embodiment.

FIG. 32 is a conceptual diagram for describing a guidance example of a drone according to the fifth example embodiment.

FIG. 33 is a conceptual diagram for describing a guidance example of a drone according to the fifth example embodiment.

FIG. 34 is a flowchart for describing an example of the operation of the management device according to the fifth example embodiment.

FIG. 35 is a flowchart for describing an example of an operation of a drone that uses a corridor to be managed by a management device according to the fifth example embodiment.

FIG. 36 is a block diagram illustrating an example of a configuration of a control device according to a sixth example embodiment.

FIG. 37 is a block diagram illustrating an example of a configuration of hardware that executes control and processing according to each example embodiment.

### EXAMPLE EMBODIMENT

Hereinafter, embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

### First Example Embodiment

First, a drone according to a first example embodiment will be described with reference to the drawings. The drone of the present example embodiment autonomously navigates a corridor that is an airspace (corridor) in which the drone flies exclusively (also referred to as autonomous navigation). Hereinafter, an example in which a flying type drone navigates a corridor formed above a river will be described. The corridor may be formed above not only a river but also a power transmission line, a railroad, a road, and the like. As long as the drone can navigate, the formation area of the corridor is not particularly limited. The drone is not limited to a flying type, and may be one that travels on the ground or one that navigates on a water surface or under water. The drone is not limited to an unmanned aerial vehicle, and may be a flying vehicle on which a person can board. The corridor may be a drone highway. The drone highway is an airspace that is maintained in such a way that the drone can fly safely and is dedicated to the drone. The drone highway is managed by an administrator who has control of the drone utilizing the drone highway. The drone highway is an area where comprehensive services are provided by the administrator of the drone highway. For example, the flight of a drone utilizing the drone highway is automated under the control of an administrator. For example, the drone highway may be an airspace in which ancillary services for the safe navigation of the drone are provided in peripheral facilities of the drone highway.

### (Configuration)

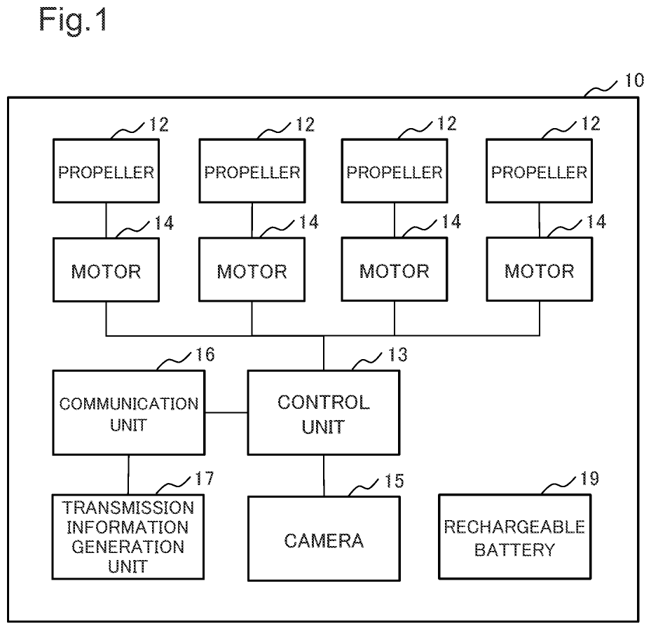

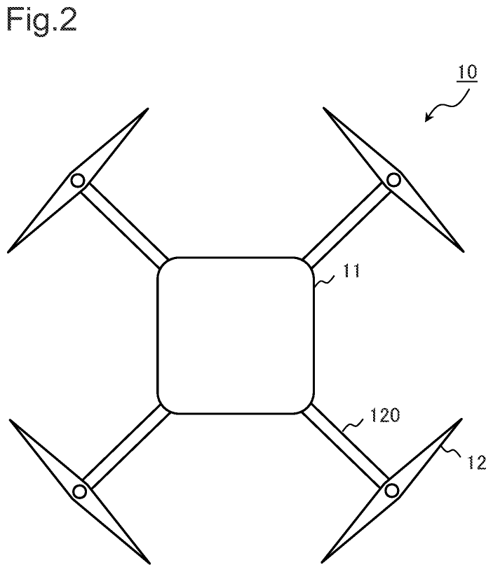

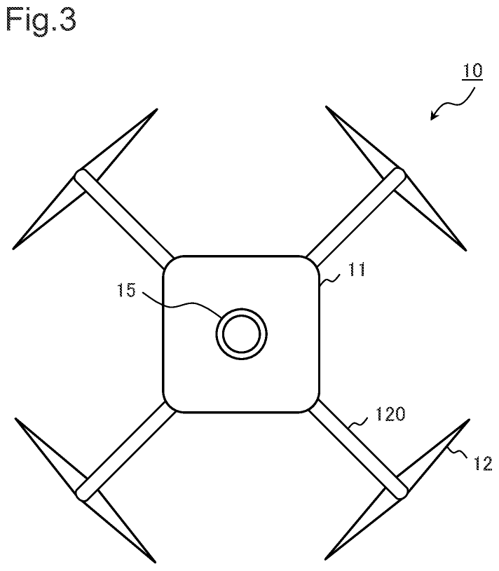

FIGS. 1 to 3 are conceptual diagrams illustrating an example of a configuration of a drone 10 according to the present example embodiment. FIG. 1 is a block diagram for describing a functional configuration of the drone 10. FIG. 2 is a plan view of the drone 10. FIG. 3 is a bottom view of the drone 10. A side view, a rear view, a slope view, and the like of the drone 10 are omitted. The drone 10 is equipped with a remote identification (RID) device that transmits transmission information including a registration number, a manufacturing number, position information, time, and authentication information.

The drone 10 includes a main body 11, a propeller 12, a control unit 13, a motor 14, a camera 15, a communication unit 16, a transmission information generation unit 17, and a rechargeable battery 19. The control unit 13, the communication unit 16, the transmission information generation unit 17, and the rechargeable battery 19 are accommodated in the main body 11. Most of the camera 15 except for the lens is accommodated in the main body 11. FIG. 3 illustrates a lens portion of the camera 15. The drone 10 has a load carrying function (not illustrated). For example, the drone 10 carries a load by accommodating the load inside the main body 11, hanging the load from the main body 11, or loading the load on the main body 11. In the case of hanging a load from the main body 11, the camera 15 may be attachable under the load in order to capture an image below the drone 10.

The main body 11 is a housing that accommodates the control unit 13, the camera 15, the communication unit 16, the transmission information generation unit 17, the rechargeable battery 19, and the like. At least one propeller 12 for causing the drone 10 to fly is attached to the main body 11. For example, the main body 11 is provided with a space for accommodating a load therein, a mechanism for hanging a load, a place for placing a load thereon, and the like depending on the application. The shape and material of the main body 11 are not particularly limited.

The propeller 12 is a mechanism that causes the drone 10 to fly. The propeller 12 is also referred to as a rotor or a rotary wing. The propeller 12 is fixed to the main body 11 by an arm 120. The propeller 12 is a blade for floating the main body 11 by rotating. The motor 14 for rotating the propeller 12 is installed in the propeller 12. The size and mounting position of the propeller 12 in FIGS. 2 to 3 are not sufficiently designed for flying the drone 10, but are conceptual. In the example of FIGS. 2 to 3, four propellers 12 are installed on the main body 11 of the drone 10. The rotation speeds of the plurality of propellers 12 is controlled independently of each other.

FIGS. 2 to 3 illustrate a quadcopter with four propellers 12 as an example. The drone 10 may include a single propeller 12 or may be a multicopter including a plurality of propellers 12. Considering the attitude stability in the air and the flight performance, the drone 10 is preferably a multicopter including a plurality of propellers 12. In a case where the plurality of propellers 12 is provided in the drone 10, the sizes of the propellers 12 may be different. The rotating surfaces of the plurality of propellers 12 may be different from each other.

The motor 14 is installed in each of the plurality of propellers 12. The motor 14 is a drive mechanism for rotating the propeller 12. The motor 14 rotates the propeller 12 under the control of the control unit 13.

The control unit 13 is a control device that controls the drone 10. For example, the control unit 13 is achieved by a control device such as a microcomputer or a microcontroller. The control unit 13 controls the rotation of the propeller 12. The control unit 13 controls the rotation speed of each propeller 12 by driving and controlling the motor 14 of each propeller 12. For example, the control unit 13 controls the navigation of the drone 10 by controlling the rotation speed of each propeller 12 according to the feature included in the image captured by the camera 15. For example, the control unit 13 navigates the drone 10 by controlling the rotation of the propeller 12 according to a preset navigation route. For example, the control unit 13 causes the drone 10 to navigate by controlling the rotation of the propeller 12 according to a preset flight condition. For example, the flight condition is a condition in which the operation performed by the drone 10 is summarized in a table form. The navigation route and the flight conditions may be stored in a storage unit (not illustrated).

The control unit 13 performs imaging control of the camera 15. The control unit 13 causes the camera 15 to capture an image at a predetermined timing. The control unit 13 acquires an image captured by the camera 15. The control unit 13 may acquire an image captured by the camera 15 without performing imaging control of the camera 15. In a case of providing an image to the management side of the corridor, the control unit 13 outputs the acquired image to the communication unit 16.

The control unit 13 controls the rotation of the propeller 12 based on the position of the guide light included in the image captured by the camera 15 while the drone 10 is navigating the inside of the corridor.

The control unit 13 controls the rotation of the propeller 12 in such a way that the drone 10 navigates an appropriate position according to the position of the guide light that emits light in a color to be referred to. For example, the control unit 13 controls the rotation of the propeller 12 in such a way as to maintain a positional relationship with a predetermined guide light.

The camera 15 is disposed to image the surroundings of the drone 10. In the case of FIG. 3, the camera 15 captures an image below the drone 10. A plurality of cameras 15 may be mounted on the drone 10 in order to image the front, the side, and the upper side of the drone 10. For example, the camera 15 may be disposed in such a way as to be able to capture images in a plurality of directions by changing the aerial posture of the drone 10. The camera 15 captures an image under the control of the control unit 13. The camera 15 may capture an image at a predetermined timing without being controlled by the control unit 13. The camera 15 outputs captured image data (also referred to as an image) to the communication unit 16. An imaging lens is incorporated in the camera 15. The lens is preferably a zoom lens capable of changing a focal length. The lens may be provided with a protection member such as a protection film or a protection glass. The camera 15 is preferably equipped with an autofocus function of automatically focusing. The camera 15 is preferably equipped with a function applied to a general digital camera, such as a function of preventing camera shake. A specific structure of the camera 15 will not be described.

The communication unit 16 receives the wireless signal transmitted from the management tower 190. The communication unit 16 transmits a signal including transmission information generated by the transmission information generation unit 17 and an image captured by the camera 15. The transmission information includes registration information, a manufacturing number, position information, time, authentication information (also referred to as identification information), and the like of the drone 10. The registration information, the manufacturing number, the authentication information, and the like of the drone 10 are information that does not change during use of the corridor (also referred to as invariable information). The position information and the time are information (also referred to as variation information) that is updated as needed. For example, the communication unit 16 transmits a signal at a transmission cycle of one or more times per second by a communication method such as Bluetooth (registered trademark).

The transmission information generation unit 17 generates transmission information unique to the drone 10. The transmission information includes invariable information and variation information. The transmission information generation unit 17 generates transmission information including invariable information and variation information at a predetermined cycle. For example, the transmission information generation unit 17 generates the transmission information at a predetermined cycle of about 3 times per second. The invariable information includes registration information, a manufacturing number, authentication information, and the like of the drone 10. The invariable information may be stored in a storage unit (not illustrated). The variation information includes position information and time. For example, the transmission information generation unit 17 generates the position information using data collected by a positioning system such as a global positioning system (GPS). The transmission information generation unit 17 may acquire the position information about a position measurement device from the position measurement device (not illustrated) installed around the corridor. In a case where a sensor capable of identifying the flight position is mounted on the drone 10, the transmission information generation unit 17 may generate the position information using the data collected by these sensors. Examples of such a sensor include an earth magnetism sensor, an acceleration sensor, a speed sensor, an altitude sensor, and a distance measurement sensor. The transmission information generation unit 17 outputs the generated transmission information to the communication unit 16.

The rechargeable battery 19 is a general secondary battery having a charging function. The rechargeable battery 19 is a power source of the drone 10. The rechargeable battery 19 is not particularly limited as long as the drone 10 can navigate the corridor. For example, the rechargeable battery 19 is preferably capable of controlling the charge of the rechargeable battery 19 and monitoring the amount of charge of the rechargeable battery 19.

### [Corridor]

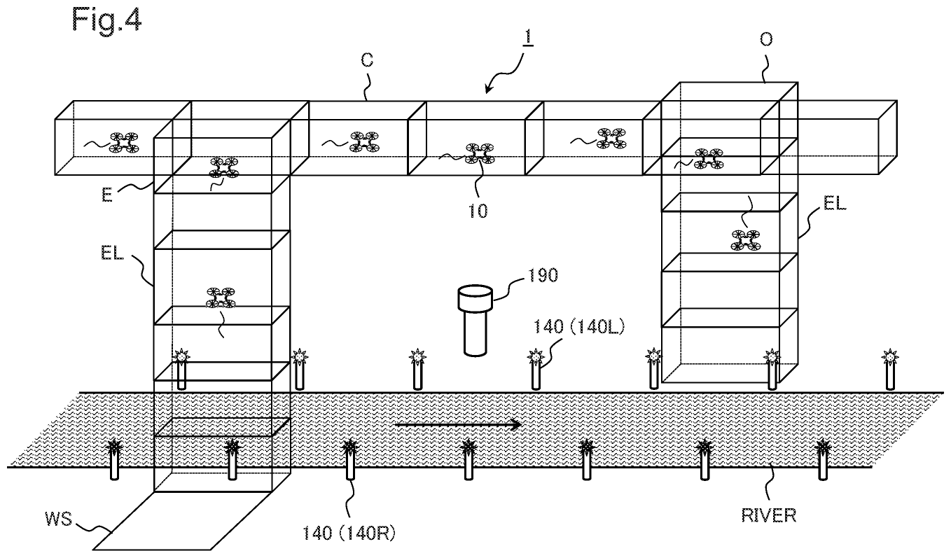

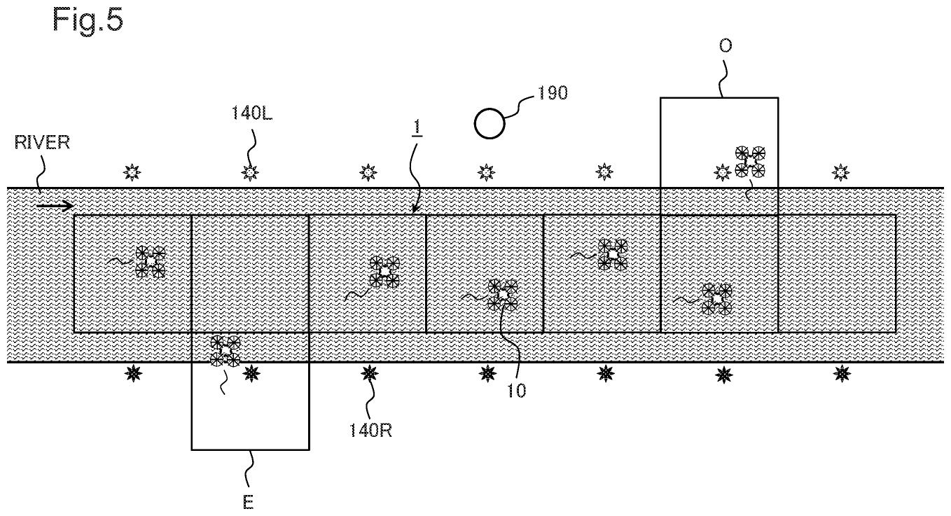

Next, a corridor through which the drone 10 navigates will be described with reference to the drawings. FIGS. 4 to 5 are conceptual diagrams illustrating an example of a corridor 1 formed above a river. FIG. 4 is a conceptual view of the corridor 1 when viewed obliquely from above. FIG. 5 is a conceptual view of the corridor 1 when viewed from above. FIGS. 4 to 5 illustrate a state in which a plurality of drones 10 navigates the inside of the corridor 1.

For example, the corridor 1 is formed at an altitude of 150 m (meters) or less from the surface of a river. In the examples of FIGS. 4 to 5, the left side is upstream and the right side is downstream. In the following drawings, the direction in which a river flows is indicated by an arrow. When a river is viewed from upstream (left side) toward downstream (right side), a bank on the right side is referred to as a right bank, and a bank on the left side is referred to as a left bank.

The position where the corridor 1 is formed is defined by a plurality of guide lights 140 disposed on both banks of the river. In FIGS. 4 to 5, the guide light 140 installed on the left bank is denoted as a guide light 140L, and the guide light 140 installed on the right bank is denoted as a guide light 140R. The guide light 140L installed on the left bank and the guide light 140R installed on the right bank emit light in different colors. For example, the guide light 140L disposed on the left bank emits green light, and the guide light 140R disposed on the right bank emits red light. The light emission color of the guide light 140 is not particularly limited as long as the guide light 140 installed at the bank on the same side emits light in the same color. In addition to the guide light 140, a warning light indicating prohibition of entry of the drone 10 may be installed. The warning light is installed at a position farther from the river than the guide light 140. For example, the warning light emits yellow light.

The traveling direction inside the corridor 1 is a direction from the left to the right on the paper surface of FIGS. 4 to 5. For example, the plurality of drones 10 is equipped with a camera 15 that captures an image below. The drone 10 navigates the inside of the corridor 1 according to the light emission color of the guide light 140 included in the image below captured by the camera 15. For example, the drone 10 navigates according to the guide light 140 disposed on one bank of the river. For example, the drone 10 may navigate according to the guide lights 140 disposed on both banks of the river.

FIGS. 4 to 5 illustrate a standby space WS, an up-and-down route EL, a plurality of corridor regions C, an entrance region E, and an exit region O. The standby space WS is a space where the drone 10 using the corridor 1 waits. The up-and-down route EL is an airspace for traveling from the ground toward the corridor 1. The plurality of corridor regions C is airspaces serving as the main line of the corridor 1. The entrance region E is an airspace for the drone 10 to enter the corridor 1. The exit region O is an airspace for the drone 10 to exit from the corridor 1.

A management tower 190 is disposed beside the river. The management tower 190 has a communication function and a camera. The management tower 190 receives a signal transmitted from the drone 10 navigating the inside of the corridor 1. The signal transmitted from the drone 10 includes transmission information for identifying each drone 10. For example, the transmission information is transmitted from a remote identification (RID) device mounted on the drone 10. The transmission information includes registration information, a manufacturing number, position information, time, authentication information, and the like of each drone 10. For example, the drone 10 navigating the inside of the corridor 1 transmits transmission information at a transmission cycle of one or more times per second by a communication method such as Bluetooth (registered trademark). The management tower 190 images the drone 10 using the corridor 1. The management tower 190 transmits transmission information included in signals transmitted from the plurality of drones 10 and captured images to a management device (not illustrated) that manages the corridor 1. The transmission information transmitted from the management tower 190 is used for management of the drone 10 using the corridor 1. For example, any of the plurality of guide lights 140 disposed on both banks of the river may have the function of the management tower 190.

### [Control Unit]

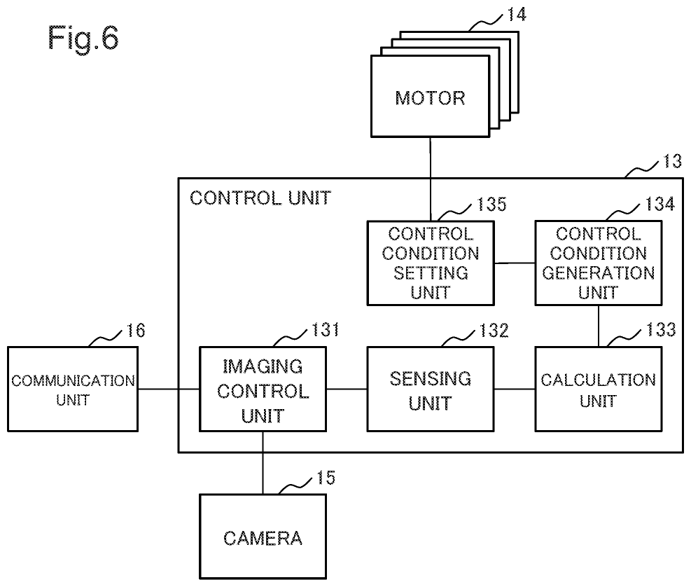

Next, the configuration of the control unit 13 mounted on the drone 10 will be described in detail. FIG. 6 is a block diagram illustrating an example of a configuration of the control unit 13. The control unit 13 includes an imaging control unit 131, a sensing unit 132, a calculation unit 133, a control condition generation unit 134, and a control condition setting unit 135.

The imaging control unit 131 performs imaging control of the camera 15. The imaging control unit 131 causes the camera 15 to capture an image at a predetermined timing. The imaging control unit 131 acquires an image captured by the camera 15. The imaging control unit 131 outputs the acquired image to the sensing unit 132. In a case where an image is provided to the management side of the corridor, the imaging control unit 131 outputs the acquired image to the communication unit 16. The imaging condition of the image used by the imaging control unit 131 and the imaging condition of the image to be output to the communication unit 16 may be set to different conditions. For example, an imaging condition of an image used by the imaging control unit 131 is set to a condition under which imaging is performed at a high frequency with low resolution to the extent that the position of the guide light 140 can be detected. For example, the imaging condition of the image output to the communication unit 16 is set to a condition under which imaging is performed at a low frequency with high resolution to the extent that the situation around the drone 10 can be verified. By setting the imaging conditions in this manner, it is possible to separate information required for navigation control and information required for verification of the surrounding situation.

The sensing unit 132 acquires an image captured by the camera 15 from the imaging control unit 131. The sensing unit 132 detects light emission of the guide light 140 from the acquired image. The sensing unit 132 extracts a light emission color of the guide light 140 to be referred to out of the detected light emission of the guide light 140. For example, it is assumed that the guide light 140L on the left bank emits green light and the guide light 140R on the right bank emits red light. Based on the light emission of the guide light 140 extracted from the image, the sensing unit 132 identifies the positions of the guide light 140 and the host drone (drone 10) in the region where the corridor 1 is formed. The sensing unit 132 outputs the positions of the guide light 140 extracted from the image and the position of the host drone (drone 10) to the calculation unit 133.

For example, in a case where the drone 10 navigates from upstream to downstream, the sensing unit 132 identifies the position of the host drone (drone 10) in the corridor 1 according to the light emission color (green) of the guide light 140L on the left bank. For example, in a case where the drone 10 navigates from the downstream to the upstream, the sensing unit 132 identifies the position of the host drone (drone 10) in the corridor 1 according to the light emission color (red) of the guide light 140R on the right bank. The sensing unit 132 may identify the position of the host drone (drone 10) in the corridor 1 according to the light emission colors (green, red) of the guide lights 140 on both banks.

The sensing unit 132 may identify the position of the host drone (drone 10) according to not only the light emission color of the guide light 140 but also the feature extracted from the image. For example, the sensing unit 132 may identify the position of the host drone (drone 10) according to the feature of the water surface of the river extracted from the image. For example, the sensing unit 132 may identify the position of the host drone (drone 10) according to features of a river bed, a bank, and the like extracted from the image. For example, the sensing unit 132 may identify the position of the host drone (drone 10) based on a structure such as a bridge or a power transmission line extracted from the image. For example, the sensing unit 132 may identify the position of the host drone (drone 10) based on the shape or symbol of a sign installed in the river or the periphery thereof extracted from the image.

The calculation unit 133 acquires the positions of the guide light 140 and the host drone (drone 10) from the sensing unit 132. In a case where the host drone (drone 10) has a function of receiving a global positioning system (GPS) signal, the calculation unit 133 may acquire position information included in the GPS signal. The calculation unit 133 calculates a positional relationship between the guide light 140 and the host drone (drone 10) according to the acquired positions of the guide light 140 and the host drone (drone 10). The positional relationship calculated by the calculation unit 133 includes the distance between the guide light 140 and the host drone (drone 10). The calculation unit 133 calculates the distance between the guide light 140 and the drone 10 identified by the sensing unit 132. For example, the control timing of the drone 10 is set at a time interval at which the drone 10 can safely autonomously navigate the corridor 1. The control timing of the drone 10 may be common to all the drones 10 navigating the corridor 1, or may be different for each drone 10.

For example, the calculation unit 133 calculates the distance between the guide light 140 closest to the drone 10 and the drone 10. For example, the calculation unit 133 calculates a distance between a straight line passing through two guide lights 140 close to the drone 10 and the drone 10. For example, the calculation unit 133 calculates a distance between a curve smoothly connecting the plurality of guide lights 140 identified from the image and the drone 10. A method of calculating the distance between the guide light 140 and the drone 10 is not particularly limited as long as the drone 10 can navigate the corridor 1.

A distance (also referred to as a designated distance) of the drone 10 with respect to the guide light 140 is set in advance for each drone 10 using the corridor 1. The designated distance may be changed according to the usage condition of the corridor 1. For example, the designated distance is defined by a minimum designated distance and a maximum designated distance. The drone 10 navigates a range (also referred to as a designation range) inside the minimum designated distance and the maximum designated distance set for each drone 10. For example, the minimum designated distance is set to a distance where the guide light 140 is closest to each drone 10. For example, the maximum designated distance is set to a distance where the guide light 140 is farthest from the individual drone 10. For example, the minimum designated distance and the maximum designated distance may be set for the center or another portion of the drone 10.

The calculation unit 133 calculates the position (also referred to as a predicted arrival position) of the drone 10 at the next control timing (also referred to as the next time control timing) for the drone 10, the next control timing being subsequent to the image capturing timing. For example, the calculation unit 133 calculates the position of the drone 10 in a case where the navigation is continued in the direction/speed of the image capturing timing as the predicted arrival position. The calculation unit 133 calculates a target position (also referred to as a control target position) of the drone 10 at the next time control timing. The control target position is set inside the designation range. For example, the control target position is set along an intermediate line between the boundary line of the minimum designated distance and the boundary line of the maximum designated distance. The calculation unit 133 outputs the calculated predicted arrival position and the calculated control target position to the control condition generation unit 134.

The control condition generation unit 134 acquires the predicted arrival position and the control target position calculated by the calculation unit 133. The control condition generation unit 134 generates a control condition for controlling the drone 10 from the predicted arrival position toward the control target position. The control condition is a condition for rotating the propeller 12 that causes the drone 10 to fly. The control condition generation unit 134 calculates the traveling direction/speed of the drone 10 from the predicted arrival position according to the control target position. The control condition generation unit 134 sets the rotation speeds of the plurality of propellers 12 according to the traveling direction/speed. The control condition generation unit 134 outputs the generated control condition to the control condition setting unit 135.

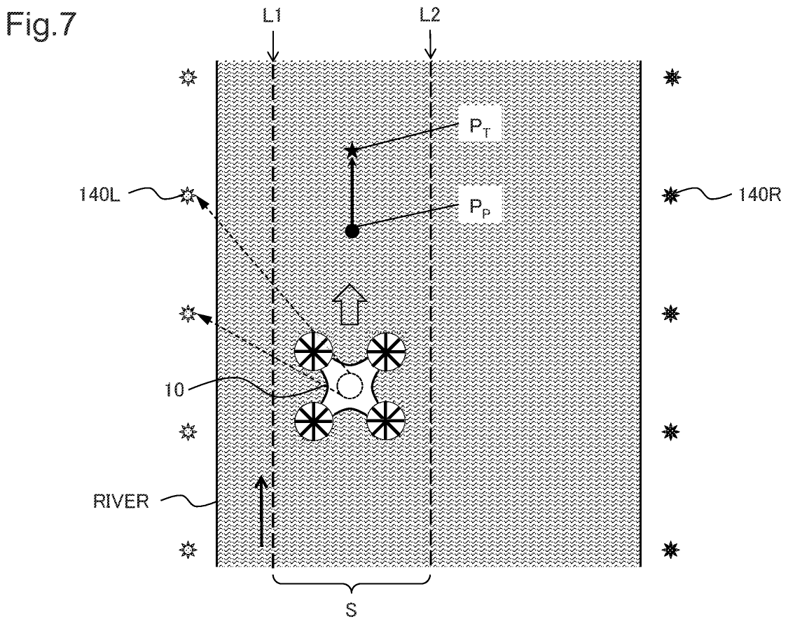

FIGS. 7 to 9 are conceptual diagrams for describing an example of control of the drone 10. In FIGS. 7 to 9, the river flows from the bottom (upstream) to the top (downstream) of the paper surface. The drone 10 navigates the inside of the corridor 1 according to the light emission of the guide light 140L installed on the left bank (left side of the paper surface) of the river. The drone 10 may navigate the inside of the corridor 1 according to the light emission of the guide light 140R installed on the right bank (right side of the paper surface) of the river. In FIG. 7, the corridor 1 is omitted. In the drone 10, a first designation line L1 that designates a minimum designated distance and a second designation line L2 that designates a maximum designated distance are set for the guide light 140L. The drone 10 is permitted to navigate a designation range S between the first designation line L1 and the second designation line L2.

In the example of FIG. 7, both the predicted arrival position P_{P} and the control target position P_{T} are within the designation range S. The drone 10 is located inside the designation range S. Therefore, the control condition generation unit 134 does not change the traveling direction of the drone 10 at the next time control timing. The control condition generation unit 134 generates a control condition from the predicted arrival position P_{P} toward the control target position P_{T} without changing the traveling direction.

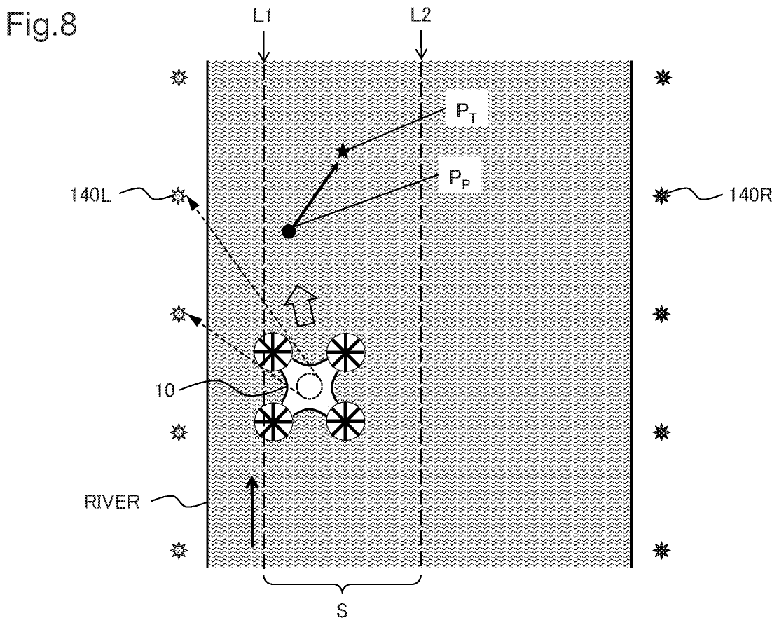

In the example of FIG. 8, both the predicted arrival position P_{P} and the control target position P_{T} are within the designation range S. However, part of the drone 10 is located outside the designation range S beyond the first designation line L1. Therefore, the control condition generation unit 134 changes the traveling direction of the drone 10 at the next time control timing toward the control target position. The control condition generation unit 134 generates a control condition from the predicted arrival position P_{P} toward the control target position P_{T}.

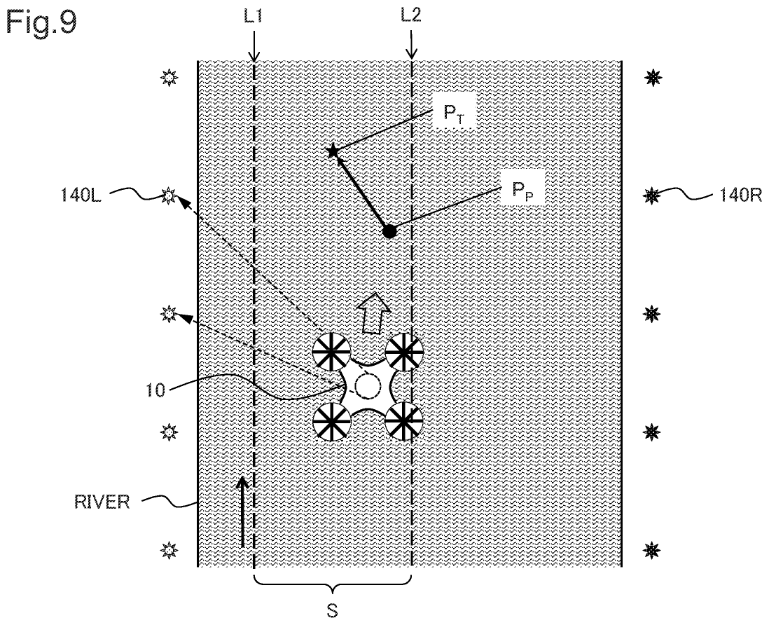

In the example of FIG. 9, both the predicted arrival position P_{P} and the control target position P_{T} are within the designation range S. However, part of the drone 10 is located outside the designation range S beyond the second designation line L2. Therefore, the control condition generation unit 134 changes the traveling direction of the drone 10 at the next time control timing toward the control target position. The control condition generation unit 134 generates a control condition from the predicted arrival position P_{P} toward the control target position P_{T}.

The control condition setting unit 135 acquires the control condition from the control condition generation unit 134. The control condition setting unit 135 sets the control condition for the motor 14 at the next time control timing. The rotation speed of each propeller 12 is controlled by driving the motor 14 according to the control condition. As a result, the drone 10 travels in a direction/speed according to the control condition.

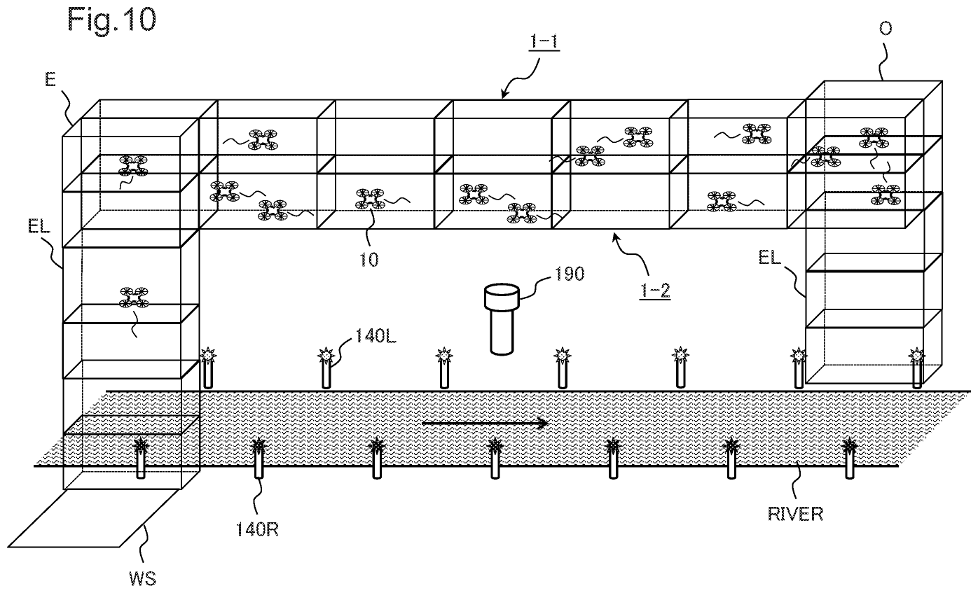

FIG. 10 is a conceptual diagram for describing another example of the corridor 1. FIG. 10 illustrates an example in which a downstream route corridor 1-1 from upstream to the downstream side and an upstream route corridor 1-2 from the downstream side to the upstream side are formed above the river. As illustrated in FIG. 10, a plurality of routes can be formed above the river. For example, the plurality of paths is formed according to altitude. For example, the plurality of paths may be formed in a plane parallel to the water surface of the river.

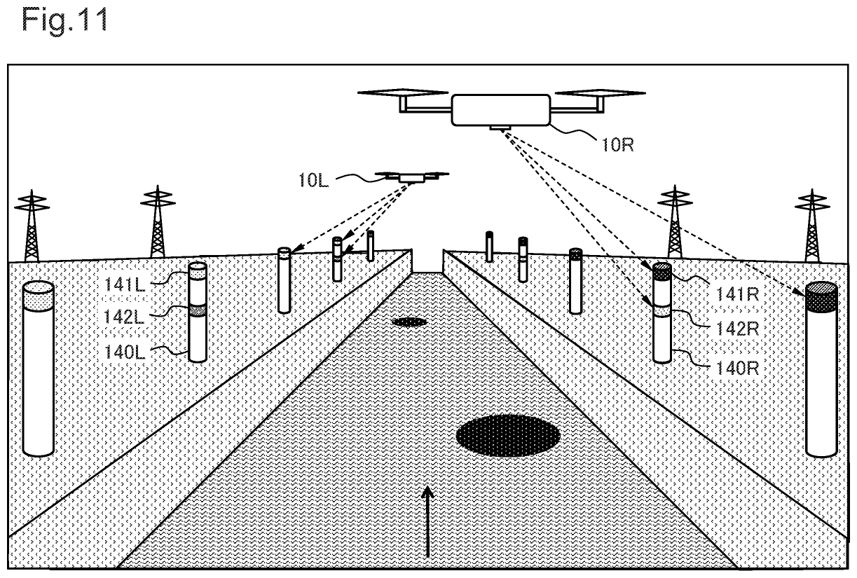

FIG. 11 is a conceptual diagram for describing still another example of the corridor 1. FIG. 11 illustrates an example in which a drone 10L navigating from the lower side (upstream) to the upper side (downstream) of the paper plane and a drone 10R navigating from the downstream to the upstream side navigate above the river. FIG. 11 illustrates an example in which a plurality of light emitting units is installed in the guide light 140.

In FIG. 11, a first light emitting unit 141L is installed at the upper part of the guide light 140L for guiding the drone 10L. For example, the first light emitting unit 141L emits green light. The second light emitting units 142L are installed in at least some of the guide lights 140L. For example, the second light emitting unit 142L emits yellow light. The drone 10L navigates while referring to the first light emitting unit 141L and the second light emitting unit 142L.

For example, the drone 10L navigates while referring to one of the first light emitting unit 141L and the second light emitting unit 142L. Normally, the drone 10L travels while referring to the first light emitting unit 141L. The drone 10L switches to refer to the second light emitting unit 142L according to an instruction from the management side.

For example, the drone 10L navigates while referring to both the first light emitting unit 141L and the second light emitting unit 142L. The first light emitting unit 141L and the second light emitting unit 142L are installed at different heights. Therefore, by referring to both the first light emitting unit 141L and the second light emitting unit 142L, the designation range where the drone 10 travels can be three-dimensionally set.

In FIG. 11, a first light emitting unit 141R is installed at the upper part of the guide light 140R for guiding the drone 10R. For example, the first light emitting unit 141R emits red light. The second light emitting units 142R are installed in at least some of the guide lights 140R. For example, the second light emitting unit 142L emits blue light. As in the drone 10L, the drone 10R navigates while referring to the first light emitting unit 141R and the second light emitting unit 142R.

As illustrated in FIG. 11, when a plurality of light emitting units is installed in the guide light 140, the designation range can be three-dimensionally set for the drone 10. In a case where a plurality of light emitting units is installed in the guide light 140, a corridor according to a purpose of use can be formed by designating a light emitting unit to be referred to. For example, different corridors can be set to be used according to the weight and size of the cargo carried by the drone 10 and the speed of the drone 10. For example, a low-speed corridor for the drone 10 that transports a heavy load is set in the lower second light emitting unit 142L and the lower second light emitting unit 142R. Then, a high-speed corridor for the drone 10 that transports a light load is set in the upper first light emitting unit 141L and the upper first light emitting unit 141R. In this way, it is possible to avoid a collision that may occur between the drones 10 according to the speed difference. For example, the upper first light emitting unit 141L and the upper first light emitting unit 141R may be used for reference of a normal corridor, and the lower second light emitting unit 142L and the lower second light emitting unit 142R may be used for reference of an emergency corridor. In this way, when an emergency situation occurs, the emergency corridor can be sequentially formed.

### (Operation)

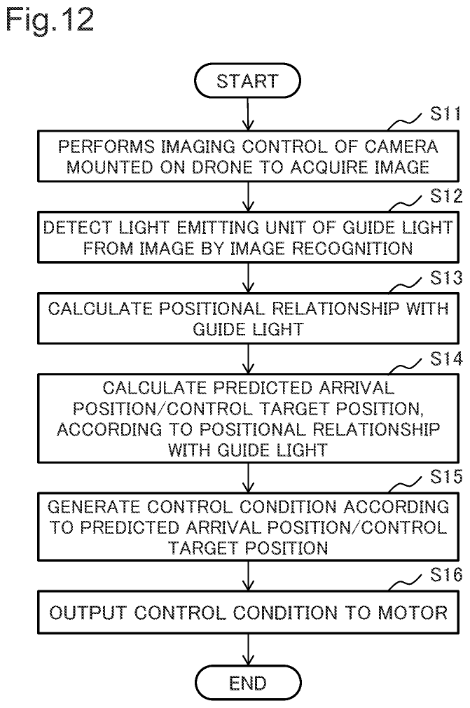

Next, an example of the operation of the control unit 13 mounted on the drone 10 of the present example embodiment will be described with reference to the drawings. FIG. 12 is a flowchart for describing an example of the operation of the control unit 13. Hereinafter, the control unit 13 will be described as an operation subject.

In FIG. 12, first, the control unit 13 performs imaging control of the camera 15 mounted on the drone 10 to acquire an image (step S11). The image captured by the camera 15 includes the guide light 140 installed on the bank of the river.

Next, the control unit 13 detects the light emitting unit of the guide light 140 to be referred to by image recognition from the image captured by the camera 15 (step S12).

Next, the control unit 13 calculates a positional relationship between the drone 10 and the guide light 140 (step S13). For example, the control unit 13 calculates the distance between the drone 10 and the guide light 140 as the positional relationship between the guide light 140 and the drone 10.

Next, the control unit 13 calculates the predicted arrival position/the control target position, according to the positional relationship between the drone 10 and the guide light 140 (step S14).

Next, the control unit 13 generates a control condition according to the calculated predicted arrival position/control target position (step S15). The control unit 13 generates a control condition for the drone 10 to move from the predicted arrival position toward the control target position.

Next, the control unit 13 outputs the generated control condition to the motor 14 (step S16). When the motor 14 is driven according to the control condition, the drone 10 can navigate the inside of the designation range set inside the corridor. When the use of the corridor is continued, the process returns to step S11 after step S16.

As described above, the drone of the present example embodiment includes the main body, the propeller, the motor, the transmission information generation unit, the communication unit, the camera, the rechargeable battery, and the control unit (control device). The motor is driven and controlled by a control device. The propeller is rotatably mounted on the main body via an arm. The propeller rotates in response to driving of the motor. The transmission information generation unit generates transmission information including identification information and position information about the host drone. The communication unit communicates with a management device that manages the corridor. The communication unit transmits the transmission information to the management device. The camera is imaging controlled by the control device. The rechargeable battery is a power source of the drone.

The control unit includes the imaging control unit, the sensing unit, the calculation unit, the control condition generation unit, and the control condition setting unit. The imaging control unit performs imaging control of the camera mounted on the drone. The sensing unit detects a guide light used for forming a corridor used by the drone from the image captured by the camera. The sensing unit identifies the position of the detected guide light. The calculation unit calculates the predicted arrival position of the drone at the control timing subsequent to the image capturing timing and the control target position according to the positional relationship between the drone and the guide light according to the positions of the drone and the guide light. The control condition generation unit generates a control condition of the motor that drives the propeller of the drone according to the predicted arrival position and the control target position. For example, the control condition generation unit generates a control condition for moving the drone from the predicted arrival position toward the control target position. The control condition setting unit sets a control condition for the motor of the drone.

The control unit of the present example embodiment sets a control condition for moving the drone from the predicted arrival position toward the control target position for the motor of the drone according to the position of the guide light detected from the image captured by the camera mounted on the drone. Therefore, according to the present example embodiment, it is possible to achieve autonomous navigation of a drone using a corridor.

In an aspect of the present example embodiment, the sensing unit detects a reference guide light to be referred to by using a corridor according to a light emission color of the guide light. The sensing unit identifies the position of the detected reference guide light. According to the present aspect, by detecting the reference guide light according to the light emission color, the drone using the corridor can reliably navigate.

In an aspect of the present example embodiment, the sensing unit detects a reference guide light to be referred to using a corridor according to a plurality of light emission colors at different heights at the guide light. The sensing unit identifies the position of the drone in the height direction in the corridor according to the plurality of light emission colors of the detected reference guide light. According to the present aspect, the position of the drone in the corridor can be three-dimensionally identified according to a plurality of light emission colors at different heights at the guide light. Therefore, according to the present aspect, the drone using the corridor can autonomously navigate three-dimensionally the inside of the corridor.

In an aspect of the present example embodiment, the control condition generation unit generates a control condition for controlling the motor in such a way that the drone moves away from the reference guide light in a case where the distance between the reference guide light and the drone is smaller than the minimum designated distance set for the reference guide light. The control condition generation unit generates a control condition for controlling the motor in such a way that the drone approaches the reference guide light in a case where the distance between the reference guide light and the drone is larger than the maximum designated distance set for the reference guide light. According to the present aspect, the drone using the corridor can safely and autonomously navigate the inside of the corridor according to the distance to the reference guide light.

### Second Example Embodiment

Next, a drone according to a second example embodiment will be described with reference to the drawings. The drone of the present example embodiment performs navigation control according to the amount of charge of a rechargeable battery mounted on the drone. Hereinafter, configurations and functions similar to those of the first example embodiment may be omitted.

### (Configuration)

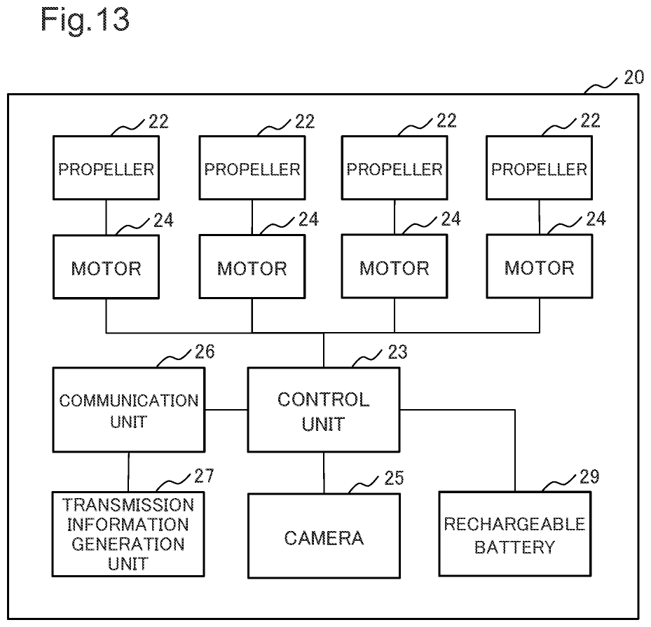

FIG. 13 is a conceptual diagram illustrating an example of a configuration of a drone 20 according to the present example embodiment. FIG. 13 is a block diagram for describing a functional configuration of the drone 20. The drone 20 has an appearance similar to that of the drone 10 of the first example embodiment.

The drone 20 includes a main body (not illustrated), a propeller 22, a control unit 23, a motor 24, a camera 25, a communication unit 26, a transmission information generation unit 27, and a rechargeable battery 29. The control unit 23, the communication unit 26, the transmission information generation unit 27, and the rechargeable battery 29 are accommodated in the main body. Most of the camera 25 except for the lens is accommodated in the main body. The drone 20 has a load carrying function (not illustrated) as in the drone 10 of the first example embodiment.

The propeller 22 has a configuration similar to that of the propeller 12 of the first example embodiment. The propeller 22 is a mechanism that causes the drone 20 to fly. The propeller 22 is fixed to the main body by an arm (not illustrated). The motor 24 for rotating the propeller 22 is installed in the propeller 22. Four propellers 22 are installed in the main body of the drone 20. The rotation speeds of the plurality of propellers 22 is controlled independently of each other.

The motor 24 has a configuration similar to that of the motor 14 of the first example embodiment. The motor 24 is installed in each of the plurality of propellers 22. The motor 24 is a drive mechanism for rotating the propeller 22. The motor 24 rotates the propeller 22 under the control of the control unit 23.

The control unit 23 has a configuration similar to that of the control unit 13 of the first example embodiment. The control unit 23 is a control device that controls the drone 20. The control unit 23 controls the rotation of the propeller 22. The control unit 23 controls the rotation speed of each propeller 22 by driving and controlling the motor 24 of each propeller 22. The control unit 23 performs imaging control of the camera 25. The control unit 23 causes the camera 25 to capture an image at a predetermined timing. The control unit 23 acquires an image captured by the camera 25. The control unit 23 controls the rotation of the propeller 22 based on the position of the guide light included in the image captured by the camera 25 while the drone 20 is navigating the inside of the corridor. The control unit 23 controls the rotation of the propeller 22 in such a way that the drone 20 navigates an appropriate position according to the position of the guide light that emits light in a color to be referred to.

Further, the control unit 23 monitors the amount of charge of the rechargeable battery 29. The control unit 23 executes control according to the amount of charge of the rechargeable battery 29. For example, in a case where the amount of charge of the rechargeable battery 29 is equal to or less than a predetermined value, the control unit 23 shifts to a preparation stage (charge standby stage) of charging the rechargeable battery 29. In the charge standby stage, when a charging station is detected in the image captured by the camera 25, the control unit 23 controls the rotation of the propeller 22 in such a way as to move toward the charging station.

The camera 25 has a configuration similar to that of the camera 15 of the first example embodiment. The camera 25 is disposed to image the surroundings of the drone 20. A plurality of cameras 25 may be mounted on the drone 20 in order to image the front, the side, the upper side, and the lower side of the drone 20. The camera 25 captures an image under the control of the control unit 23. The camera 25 outputs captured image data (also referred to as an image) to the communication unit 26.

The communication unit 26 has a configuration similar to that of the communication unit 16 of the first example embodiment. The communication unit 26 receives the wireless signal transmitted from the management tower. The communication unit 26 transmits a signal including transmission information generated by the transmission information generation unit 27 and an image captured by the camera 25.

The transmission information generation unit 27 has a configuration similar to that of the transmission information generation unit 17 of the first example embodiment. The transmission information generation unit 27 generates transmission information unique to the drone 20. The transmission information includes invariable information and variation information. The transmission information generation unit 27 generates transmission information including invariable information and variation information at a predetermined cycle. The invariable information includes registration information, a manufacturing number, authentication information, and the like of the drone 20. The variation information includes position information and time. The transmission information generation unit 27 outputs the generated transmission information to the communication unit 26.

The rechargeable battery 29 is a general secondary battery having a charging function. The rechargeable battery 29 is a power source of the drone 20. The amount of charge of the rechargeable battery 29 is monitored by control unit 23. The rechargeable battery 29 is not particularly limited as long as the drone 20 can navigate the corridor. In the rechargeable battery 29, it is possible to control charging of the rechargeable battery 29 and monitor the amount of charge of the rechargeable battery 29.

### [Control Unit]

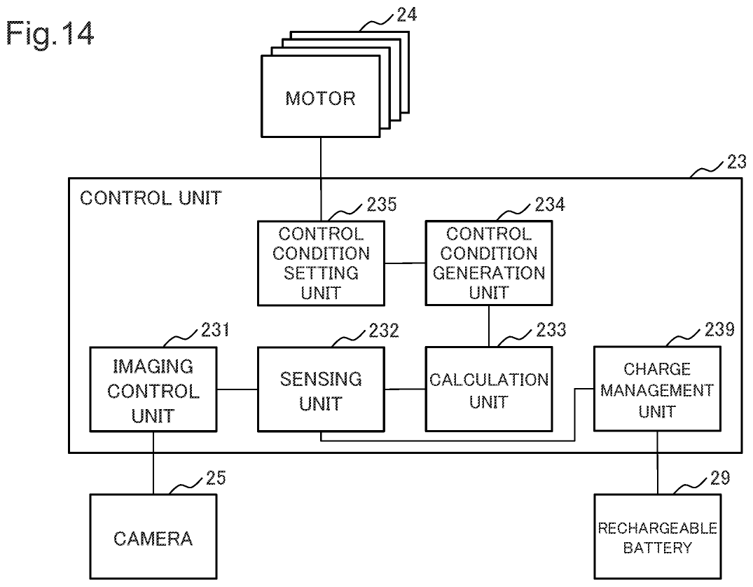

Next, the configuration of the control unit 23 mounted on the drone 20 will be described in detail. FIG. 14 is a block diagram illustrating an example of a configuration of the control unit 23. The control unit 23 includes an imaging control unit 231, a sensing unit 232, a calculation unit 233, a control condition generation unit 234, a control condition setting unit 235, and a charge management unit 239.

The imaging control unit 231 has a configuration similar to that of the imaging control unit 131 of the first example embodiment. The imaging control unit 231 performs imaging control of the camera 25. The imaging control unit 231 causes the camera 25 to capture an image at a predetermined timing. The imaging control unit 231 acquires an image captured by the camera 25. The imaging control unit 231 outputs the acquired image to the sensing unit 232. In a case where an image is provided to the management side of the corridor, the imaging control unit 231 outputs the acquired image to the communication unit 26.

The charge management unit 239 monitors the amount of charge of the rechargeable battery 29. When the amount of charge of the rechargeable battery 29 falls below the reference value, the charge management unit 239 outputs a signal (also referred to as a charge standby signal) indicating the charge standby state to the sensing unit 232.

The sensing unit 232 has a configuration similar to that of the sensing unit 132 of the first example embodiment. The sensing unit 232 acquires an image captured by the camera 25 from the imaging control unit 231. The sensing unit 232 detects light emission of a guide light (not illustrated) from the acquired image. The sensing unit 232 extracts the light emission color of the guide light to be referred to out of the detected light emission of the guide light. For example, it is assumed that the guide light on the left bank emits green light and the guide light emits red light on the right bank. The sensing unit 232 identifies the position of the guide light or the host drone (drone 20) in the region where the corridor is formed based on the light emission of the guide light extracted from the image. The sensing unit 232 outputs the guide light extracted from the image and the position of the host drone (drone 20) to the calculation unit 233.

When receiving the charge standby signal, the sensing unit 232 detects a charging station (not illustrated) from the acquired image. The sensing unit 232 identifies the position of the detected charging station. The sensing unit 232 outputs the position of the charging station to the calculation unit 233 in addition to the positions of the guide light and the host drone (drone 20). When no charging station is detected from the image, the charge standby state is maintained. The sensing unit 232 maintains the charge standby state until the charging station is detected from the image. For example, in a case where the charging station is not detected from the image even after a predetermined time has elapsed, the sensing unit 232 may output the emergency landing position to the calculation unit 233. With this configuration, even when the amount of charge of the rechargeable battery 29 is insufficient, the drone 20 can be safely landed.

The calculation unit 233 has a configuration similar to that of the calculation unit 133 of the first example embodiment. The calculation unit 233 acquires the positions of the guide light 240 and the host drone (drone 20) from the sensing unit 232. In a case where the host drone (drone 20) has a function of receiving a global positioning system (GPS) signal, the calculation unit 233 may acquire position information included in the GPS signal. The calculation unit 233 calculates a positional relationship between the guide light 240 and the host drone (drone 20) according to the acquired positions of the guide light 240 and the host drone (drone 20). The calculation unit 233 calculates the position (also referred to as a predicted arrival position) of the drone 20 at the next control timing (also referred to as the next time control timing) for the drone 20, the next control timing being subsequent to the image capturing timing. The calculation unit 233 calculates a target position (also referred to as a control target position) of the drone 20 at the next time control timing.

In the case of the charge standby state, the calculation unit 233 calculates the position of the charging station as the control target position. The calculation unit 233 outputs the calculated predicted arrival position and the calculated control target position to the control condition generation unit 234.

The control condition generation unit 234 has a configuration similar to that of the control condition generation unit 134 of the first example embodiment. The control condition generation unit 234 acquires the predicted arrival position and the control target position calculated by the calculation unit 233. The control condition generation unit 234 generates a control condition for controlling the drone 20 from the predicted arrival position toward the control target position. The control condition generation unit 234 calculates the traveling direction/speed of the drone 20 from the predicted arrival position according to the control target position. The control condition generation unit 234 sets the rotation speeds of the plurality of propellers 22 according to the traveling direction/speed. The control condition generation unit 234 outputs the generated control condition to the control condition setting unit 235.

The control condition setting unit 235 has a configuration similar to that of the control condition setting unit 135 of the first example embodiment. The control condition setting unit 235 acquires the control condition from the control condition generation unit 234. The control condition setting unit 235 sets the control condition for the motor 24 at the next time control timing. The rotation speed of each propeller 22 is controlled by driving the motor 24 according to the control condition. As a result, the drone 20 travels in a direction/speed according to the control condition.

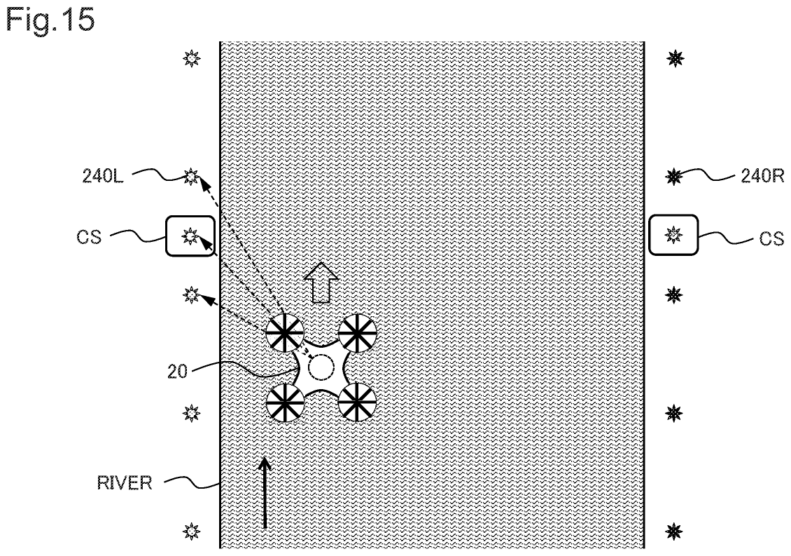

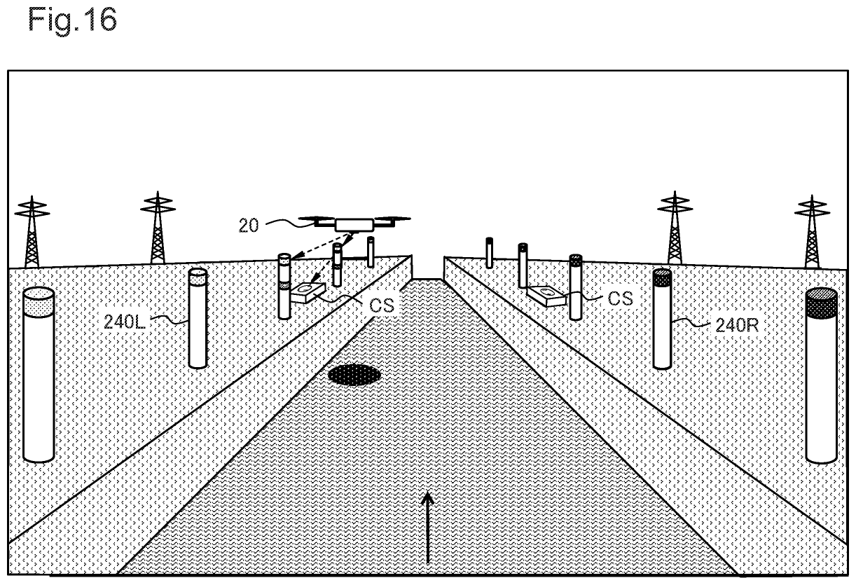

FIGS. 15 to 16 are conceptual diagrams for describing an example of control of the drone 20. In FIGS. 15 to 16, the river flows from the bottom (upstream) to the top (downstream) of the paper surface. The drone 20 navigates the inside of the corridor according to the light emission of the guide light 240L installed on the left bank (left side of the paper surface) of the river. The drone 20 may navigate the inside of the corridor according to the light emission of the guide light 240R installed on the right bank (right side of the paper surface) of the river. In FIGS. 15 to 16, a corridor is omitted.

In the example of FIG. 15, a charging station CS is included in the image captured by the camera 25 mounted on the drone 20. For example, the charging station CS emits light in a color different from that of the guide light 240L or the guide light 240R. For example, the charging station CS may emit light according to a vacant state. For example, when the charging station CS does not emit light in a case where there is no available charging port, it is possible to prevent the drone 20 from heading to the charging station CS in a situation where the charging station CS cannot be used. For example, as illustrated in FIG. 16, when the upper part or the column of the guide light 240 in the vicinity of the charging station CS can emit light of a different color, the light emission of the guide light 240 is a mark in the height direction, and thus, it is easy to three-dimensionally control the drone 20.

### (Operation)

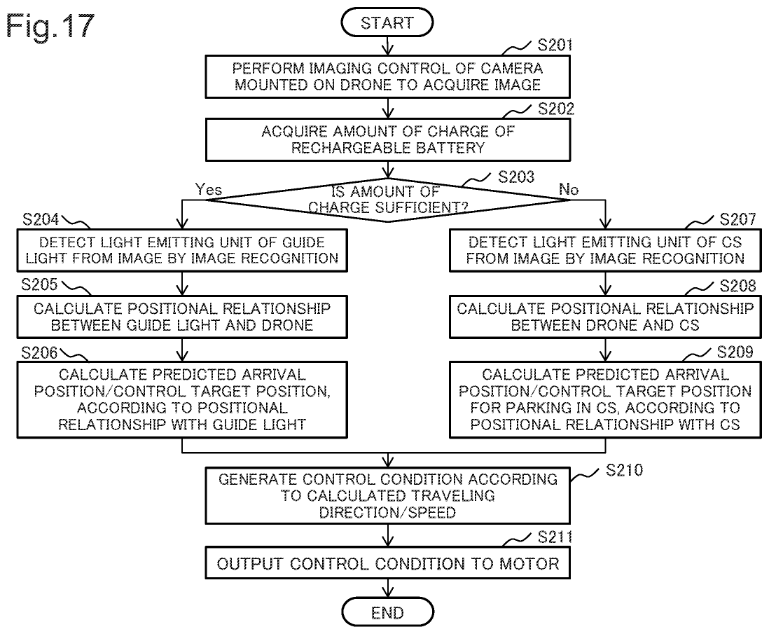

Next, an example of the operation of the control unit 23 mounted on the drone 20 of the present example embodiment will be described with reference to the drawings. FIG. 17 is a flowchart for describing an example of the operation of the control unit 23. Hereinafter, the control unit 23 will be described as an operation subject.

In FIG. 17, first, the control unit 23 performs imaging control of the camera 25 mounted on the drone 20 to acquire an image (step S201). The image captured by the camera 25 includes a guide light 240 installed on the bank of the river.

Next, control unit 23 acquires the amount of charge of the rechargeable battery 29 (step S202).

When the amount of charge of the rechargeable battery 29 exceeds a predetermined value (Yes in step S203), the control unit 23 detects the light emitting unit of guide light 240 to be referred to by image recognition from the image captured by camera 25 (step S204).

Next, the control unit 23 calculates a positional relationship between the drone 20 and the guide light 240 (step S205). For example, the control unit 23 calculates the distance between the drone 20 and the guide light 240 as the positional relationship between the drone 20 and the guide light 240.

Next, the control unit 23 calculates the predicted arrival position/the control target position according to the positional relationship between the drone 20 and the guide light 240 (step S206).

In step S203, when the amount of charge of the rechargeable battery 29 is equal to or less than the predetermined value (No in step S203), the control unit 23 detects the charging station CS by image recognition from the image captured by the camera 25 (step S207). For example, the control unit 23 detects light emission of the charging station CS.

Next, the control unit 23 calculates a positional relationship between the charging station CS and the drone 20 (step S208). For example, the control unit 23 calculates a distance between the charging station CS detected from the image and the drone 20 as a positional relationship between the charging station CS and the drone 20.

Next, the control unit 23 calculates a predicted arrival position/control target position for the drone 20 to park in the charging station CS in accordance with the positional relationship between the charging station CS and the drone 20 (step S207).

After step S206 or step S209, the control unit 23 generates a control condition according to the calculated predicted arrival position/control target position (step S210). The control unit 23 generates a control condition for the drone 20 to move from the predicted arrival position toward the control target position.

Next, the control unit 23 outputs the generated control condition to the motor 24 (step S211). When the motor 24 is driven according to the control condition, the drone 20 can navigate the inside of the designation range set inside the corridor, and the drone 20 can park in the charging station CS. When the use of the corridor is continued, the process returns to step S201 after step S211.

As described above, the drone of the present example embodiment includes the main body, the propeller, the motor, the transmission information generation unit, the communication unit, the camera, the rechargeable battery, and the control unit (control device). The motor is driven and controlled by a control device. The propeller is rotatably mounted on the main body via an arm. The propeller rotates in response to driving of the motor. The transmission information generation unit generates transmission information including identification information and position information about the host drone. The communication unit communicates with a management device that manages the corridor. The communication unit transmits the transmission information to the management device. The camera is imaging controlled by the control device. The rechargeable battery is a power source of the drone. It is possible to monitor and control the amount of charge the rechargeable battery.

The control unit includes the imaging control unit, the sensing unit, the calculation unit, the control condition generation unit, the control condition setting unit, and the charge management unit. The imaging control unit performs imaging control of the camera mounted on the drone. The charge management unit monitors the amount of charge of a rechargeable battery mounted on the drone. When the amount of charge of the rechargeable battery falls below the reference value, the charge management unit outputs a charge standby signal to the sensing unit. The sensing unit detects a guide light used for forming a corridor used by the drone from the image captured by the camera. The sensing unit identifies the position of the detected guide light. The sensing unit detects a charging station capable of charging the rechargeable battery from the image captured by the camera in response to the charge standby signal. The sensing unit identifies the position of the detected charging station. The calculation unit calculates the predicted arrival position of the drone at the control timing subsequent to the image capturing timing and the control target position according to the positional relationship between the drone and the guide light according to the positions of the drone and the guide light. The calculation unit calculates the position of the charging station as the control target position. The control condition generation unit generates a control condition of the motor that drives the propeller of the drone according to the predicted arrival position and the control target position. For example, the control condition generation unit generates a control condition for moving the drone from the predicted arrival position toward the control target position. The control condition setting unit sets a control condition for the motor of the drone.

In a case where the amount of charge of the rechargeable battery mounted on the drone falls below the reference value, the control unit of the present example embodiment detects the charging station from the image captured by the camera. The control unit sets a control condition for moving the drone toward the detected charging station (control target position) for the motor of the drone. Therefore, according to the present example embodiment, it is possible to achieve safe autonomous navigation of the drone using the corridor according to the amount of charge of the rechargeable battery mounted on the drone.

### Third Example Embodiment

Next, a drone according to a third example embodiment will be described with reference to the drawings. The drone of the present example embodiment performs navigation control according to a positional relationship with another drone. Hereinafter, an example in which a function of performing navigation control according to a positional relationship with other drones are added to the first example embodiment will be described. The functions of the present example embodiment may be added to the second example embodiment. Hereinafter, configurations and functions similar to those of the first to second example embodiments may be omitted.

### (Configuration)

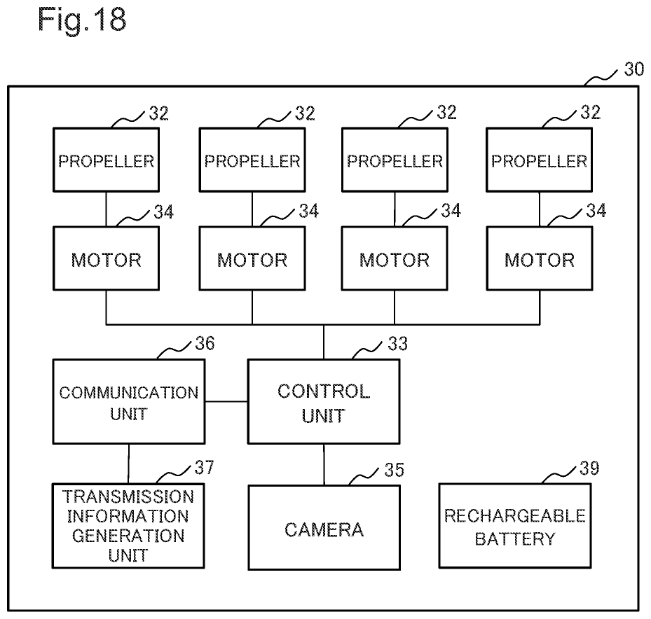

FIG. 18 is a conceptual diagram illustrating an example of a configuration of a drone 30 according to the present example embodiment. FIG. 18 is a block diagram for describing a functional configuration of the drone 30. The drone 30 has an appearance similar to that of the drone 10 of the first example embodiment.

The drone 30 includes a main body (not illustrated), a propeller 32, a control unit 33, a motor 34, a camera 35, a communication unit 36, a transmission information generation unit 37, and a rechargeable battery 39. The control unit 33, the communication unit 36, the transmission information generation unit 37, and the rechargeable battery 39 are accommodated in the main body. Most of the camera 35 except for the lens is accommodated in the main body. The drone 30 has a load carrying function (not illustrated) as in the drone 10 of the first example embodiment.

The propeller 32 has a configuration similar to that of the propeller 12 of the first example embodiment. The propeller 32 is a mechanism that causes the drone 30 to fly. The propeller 32 is fixed to the main body by an arm (not illustrated). A motor 34 for rotating the propeller 32 is installed in the propeller 32. Four propellers 32 are installed in the main body of the drone 30. The rotation speeds of the plurality of propellers 32 is controlled independently of each other.

The motor 34 has a configuration similar to that of the motor 14 of the first example embodiment. The motor 34 is installed in each of the plurality of propellers 32. The motor 34 is a drive mechanism for rotating the propeller 32. The motor 34 rotates the propeller 32 under the control of the control unit 33.

The control unit 33 has a configuration similar to that of the control unit 13 of the first example embodiment. The control unit 33 is a control device that controls the drone 30. The control unit 33 controls the rotation of the propeller 32. The control unit 33 controls the rotation speed of each propeller 32 by driving and controlling the motor 34 of each propeller 32. The control unit 33 performs imaging control of the camera 35. The control unit 33 causes the camera 35 to capture an image at a predetermined timing. The control unit 33 acquires an image captured by the camera 35. The control unit 33 controls the rotation of the propeller 32 based on the position of the guide light included in the image captured by the camera 35 while the drone 30 is navigating the inside of the corridor. The control unit 33 controls the rotation of the propeller 32 in such a way that the drone 30 navigates an appropriate position according to the position of the guide light that emits light in a color to be referred to.

The control unit 33 acquires, from the communication unit 36, position information included in transmission information about another drone 30 navigating the corridor. The control unit 33 calculates a positional relationship with the another drone 30 according to the acquired position information. The control unit 33 executes control according to a positional relationship with the another drone 30. For example, in a case where the distance to the another drone 30 is equal to or less than a predetermined value, the control unit 33 controls the rotation of the propeller 32 in such a way as to move away from the drone 30.

The camera 35 has a configuration similar to that of the camera 15 of the first example embodiment. The camera 35 is disposed to image the surroundings of the drone 30. A plurality of cameras 35 may be mounted on the drone 30 in order to image the front, the side, the upper side, and the lower side of the drone 30. The camera 35 captures an image under the control of the control unit 33. The camera 35 outputs captured image data (also referred to as an image) to the communication unit 36.

The communication unit 36 has a configuration similar to that of the communication unit 16 of the first example embodiment. The communication unit 36 receives the wireless signal transmitted from the management tower. The communication unit 36 transmits a signal including transmission information generated by the transmission information generation unit 37 and an image captured by the camera 35. Furthermore, the communication unit 36 receives a signal transmitted by the another drone 30 navigating the corridor. The signal transmitted by the another drone 30 includes transmission information unique to the drone 30. The transmission information includes position information about the drone 30 that is a signal transmission source. The communication unit 36 outputs the position information included in the received transmission information to the control unit 33.

The transmission information generation unit 37 has a configuration similar to that of the transmission information generation unit 17 of the first example embodiment. The transmission information generation unit 37 generates transmission information unique to the drone 30. The transmission information includes invariable information and variation information. The transmission information generation unit 37 generates transmission information including invariable information and variation information at a predetermined cycle. The invariable information includes registration information, a manufacturing number, authentication information, and the like of the drone 30. The variation information includes position information and time. The transmission information generation unit 37 outputs the generated transmission information to the communication unit 36.

The rechargeable battery 39 has a configuration similar to that of the rechargeable battery 19 of the first example embodiment. The rechargeable battery 39 is a general secondary battery having a charging function. The rechargeable battery 39 is a power source of the drone 30.

### [Control Unit]

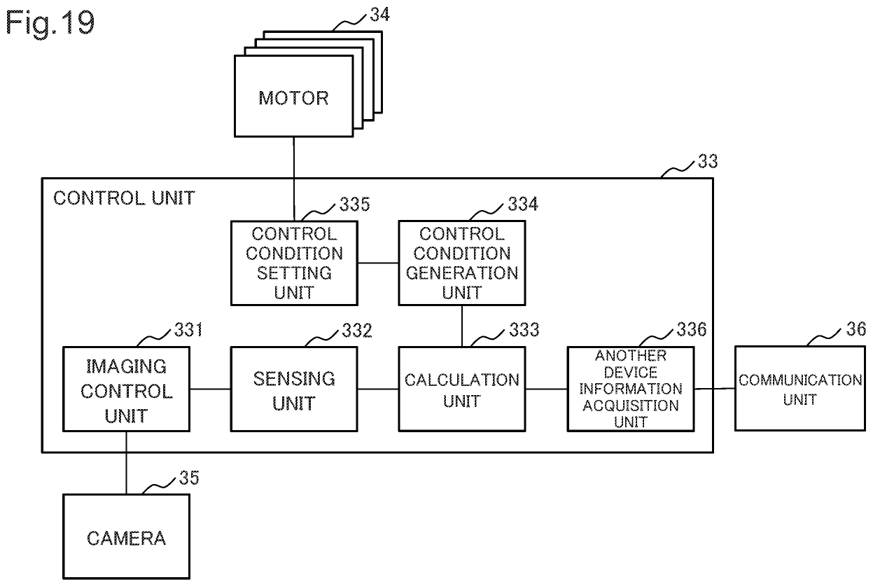

Next, the configuration of the control unit 33 mounted on the drone 30 will be described in detail. FIG. 19 is a block diagram illustrating an example of a configuration of the control unit 33. The control unit 33 includes an imaging control unit 331, a sensing unit 332, a calculation unit 333, a control condition generation unit 334, a control condition setting unit 335, and an another device information acquisition unit 336.

The imaging control unit 331 has a configuration similar to that of the imaging control unit 131 of the first example embodiment. The imaging control unit 331 performs imaging control of the camera 35. The imaging control unit 331 causes the camera 35 to capture an image at a predetermined timing. The imaging control unit 331 acquires an image captured by the camera 35. The imaging control unit 331 outputs the acquired image to the sensing unit 332. In a case where an image is provided to the management side of the corridor, the imaging control unit 331 outputs the acquired image to the communication unit 36.

The sensing unit 332 has a configuration similar to that of the sensing unit 132 of the first example embodiment. The sensing unit 332 acquires an image captured by the camera 35 from the imaging control unit 331. The sensing unit 332 detects light emission of a guide light (not illustrated) from the acquired image. The sensing unit 332 extracts the light emission color of the guide light to be referred to out of the detected light emission of the guide light. For example, it is assumed that the guide light on the left bank emits green light and the guide light emits red light on the right bank. The sensing unit 332 identifies the position of the guide light or the host drone (drone 30) in the region where the corridor is formed based on the light emission of the guide light extracted from the image. The sensing unit 332 outputs the guide light extracted from the image and the position of the host drone (drone 30) to the calculation unit 333.

The another device information acquisition unit 336 acquires position information about the another drone 30 (another device) from the communication unit 36. The another device information acquisition unit 336 outputs the acquired position information about the another device to the calculation unit 333.

The calculation unit 333 has a configuration similar to that of the calculation unit 133 of the first example embodiment. The calculation unit 333 acquires the positions of the guide light 340 and the host drone (drone 30) from the sensing unit 332. In a case where the host drone (drone 30) has a function of receiving a global positioning system (GPS) signal, the calculation unit 333 may acquire position information included in the GPS signal. The calculation unit 333 calculates a positional relationship between the guide light 340 and the host drone according to the acquired positions of the guide light 340 and the host drone. The calculation unit 333 calculates the position (also referred to as a predicted arrival position) of the drone 30 at the next control timing (also referred to as the next time control timing) for the drone 30, the next control timing being subsequent to the image capturing timing. The calculation unit 333 calculates a target position (also referred to as a control target position) of the drone 30 at the next time control timing. The calculation unit 333 outputs the calculated predicted arrival position and the calculated control target position to the control condition generation unit 334.

The calculation unit 333 acquires, from the another device information acquisition unit 336, position information about the another drone 30 (another device) navigating the corridor. When the position information about the another device is acquired, the calculation unit 333 calculates the positional relationship between the another device and the host drone using the position information about the another device. For example, the calculation unit 333 calculates the distance between the another device and the host drone as the positional relationship between the another device and the host drone. When the distance between the another device and the host drone is less than the predetermined distance, the calculation unit 333 calculates the control target position in such a way as to move away from the another device. For example, the calculation unit 333 sets the control target position in a direction in which the drone is away from the position of the another device. The calculation unit 333 outputs the calculated predicted arrival position and the calculated control target position to the control condition generation unit 334.

The control condition generation unit 334 has a configuration similar to that of the control condition generation unit 134 of the first example embodiment. The control condition generation unit 334 acquires the predicted arrival position and the control target position calculated by the calculation unit 333. The control condition generation unit 334 generates a control condition for controlling the drone 30 from the predicted arrival position toward the control target position. The control condition generation unit 334 calculates the traveling direction/speed of the drone 30 from the predicted arrival position according to the control target position. The control condition generation unit 334 sets the rotation speeds of the plurality of propellers 32 according to the traveling direction/speed. The control condition generation unit 334 outputs the generated control condition to the control condition setting unit 335.

The control condition setting unit 335 has a configuration similar to that of the control condition setting unit 135 of the first example embodiment. The control condition setting unit 335 acquires the control condition from the control condition generation unit 334. The control condition setting unit 335 sets the control condition for the motor 34 at the next time control timing. The rotation speed of each propeller 32 is controlled by driving the motor 34 according to the control condition. As a result, the drone 30 travels in a direction/speed according to the control condition.

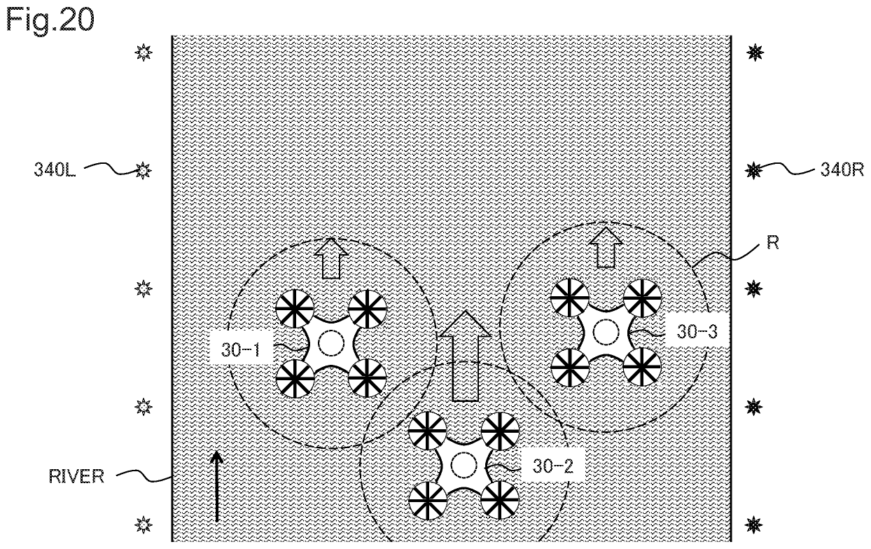

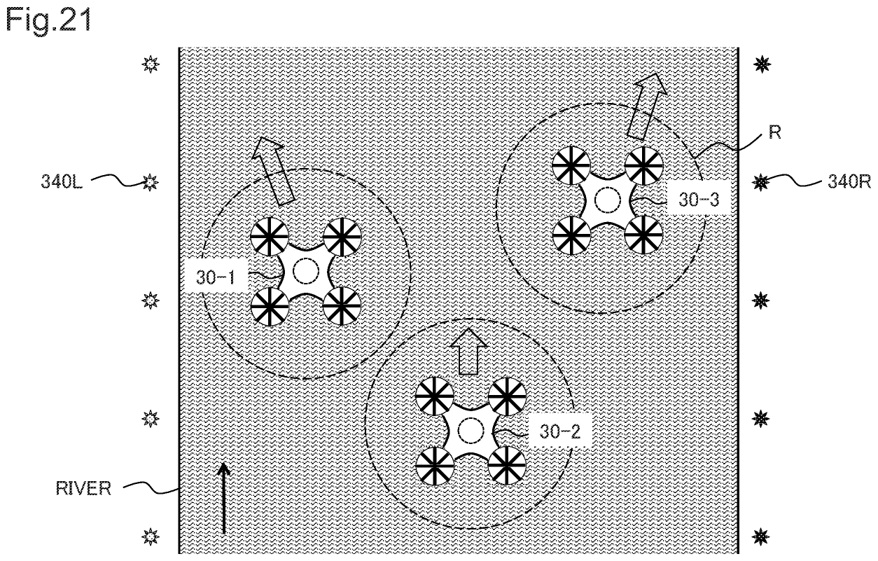

FIGS. 20 to 21 are conceptual diagrams for describing an example of control of the drone 30. In FIGS. 20 to 21, the river flows from the bottom (upstream) to the top (downstream) of the paper surface. The drone 30 navigates the inside of the corridor according to the light emission of the guide light 340L installed on the left bank (left side of the paper surface) of the river. The drone 30 may navigate the inside of the corridor according to the light emission of the guide light 340R installed on the right bank (right side of the paper surface) of the river. In FIGS. 20 to 21, a corridor is omitted. An occupation range R is set around the drones 30-1 to 30-3. In FIGS. 20 to 21, the occupation range R is indicated by a dashed circle. In the examples of FIGS. 20 to 21, the difference in speed between the drones 30-1 to 30-3 is indicated by the length of an arrow. The longer the arrow, the faster the speed, and the shorter the arrow, the slower the speed.

In the example of FIG. 20, three drones 30-1 to 30-3 are navigating a corridor. The scene of FIG. 20 is a situation in which the drone 30-2 having a high speed navigates from behind the drone 30-1 and the drone 30-3 having navigated at a normal speed. The occupation ranges R of the drone 30-1 and the drone 30-3 overlap with the occupation range R of the drone 30-2. In such a case, the drones 30-1 to 30-3 control the propellers 32 of the host drones in such a way that the occupation ranges R do not overlap each other. That is, the drones 30-1 to 30-3 perform cooperative control in such a way that the occupation ranges R do not overlap each other.

The scene of FIG. 21 is a situation as a result of execution of the cooperative control by the drones 30-1 to 30-3 after the scene of FIG. 20. The drone 30-1 moves to the left front at an increased speed in such a way as to move away from the drone 30-2. The drone 30-2 reduces the speed so as not to approach the drone 30-1 and the drone 30-2. The drone 30-3 moves rightward and forward at an increased speed in such a way as to move away from the drone 30-2. As a result of the above cooperative control, as illustrated in FIG. 21, overlapping of the occupation ranges R of the drones 30-1 to 30-3 is eliminated.

### (Operation)

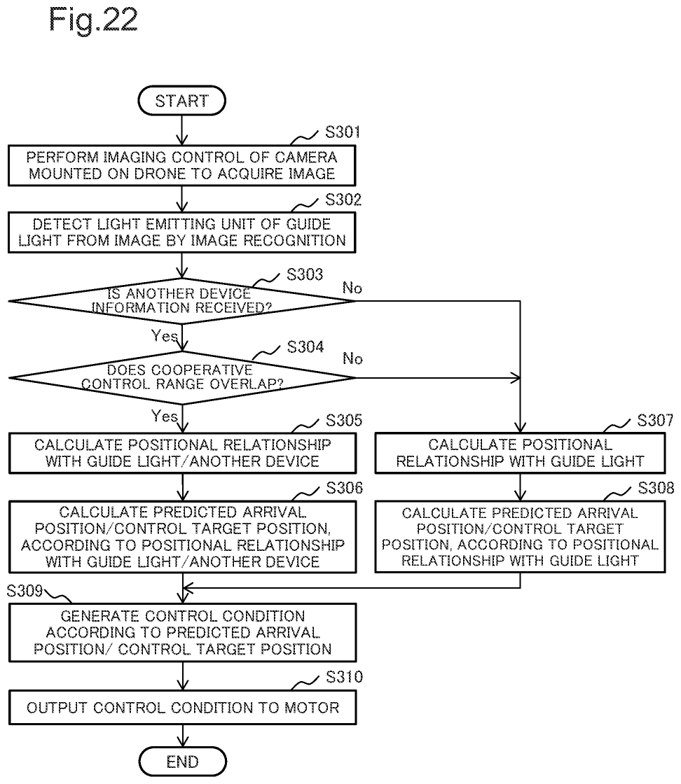

Next, an example of the operation of the control unit 33 mounted on the drone 30 of the present example embodiment will be described with reference to the drawings. FIG. 22 is a flowchart for describing an example of the operation of the control unit 33. Hereinafter, the control unit 33 will be described as an operation subject.

In FIG. 22, first, the control unit 33 performs imaging control of the camera 35 mounted on the drone 30 to acquire an image (step S301). The image captured by the camera 35 includes a guide light 340 installed on the bank of the river.

Next, the control unit 33 detects the light emitting unit of the guide light 340 to be referred to by image recognition from the image captured by the camera 35 (step S302).

When receiving the transmission information (also referred to as another device information) of the another device (Yes in step S303), the control unit 33 determines whether the cooperation range overlaps with that of the another drone 30 (another device) (step S304).

When the coordination range overlaps with that of the another drone 30 (another device) (Yes in step S304), the control unit 33 calculates a positional relationship between the guide light 340 and the host drone and a positional relationship between the another device and the host drone (step S305). For example, the control unit 33 calculates the distance between the drone 30 and the guide light 340 as a positional relationship between the drone 30 and the guide light 340. The control unit 33 calculates the distance between the another device and the host drone as a positional relationship between the another device and the host drone by using position information between the another device and the host drone.

Next, the control unit 33 calculates the predicted arrival position/control target position in accordance with a positional relationship between the guide light 340 and the host drone and a positional relationship between the another device and the host drone (step S306).

In step S303, when the amount of charge of the rechargeable battery 39 is equal to or less than the predetermined value (No in step S303), the control unit 33 detects the light emitting unit of guide light 340 to be referred to by image recognition from the image captured by camera 35.

Next, the control unit 33 calculates a positional relationship between the drone 30 and the guide light 340 (step S308). For example, the control unit 33 calculates the distance between the drone 30 and the guide light 340 as the positional relationship between the guide light 340 and the drone 30.

After step S306 or step S308, the control unit 33 generates a control condition according to the calculated predicted arrival position/control target position (step S309). The control unit 33 generates a control condition for the drone 30 to move from the predicted arrival position toward the control target position.

Next, the control unit 33 outputs the generated control condition to the motor 34 (step S310). When the motor 34 is driven in accordance with the control condition, the drone 30 can navigate the inside of the designation range set inside the corridor. When the use of the corridor is continued, the process returns to step S301 after step S310.

As described above, the drone of the present example embodiment includes the main body, the propeller, the motor, the transmission information generation unit, the communication unit, the camera, the rechargeable battery, and the control unit (control device). The motor is driven and controlled by a control device. The propeller is rotatably mounted on the main body via an arm. The propeller rotates in response to driving of the motor. The transmission information generation unit generates transmission information including identification information and position information about the host drone. The communication unit communicates with a management device that manages the corridor. The communication unit transmits the transmission information to the management device. The communication unit receives transmission information about the another drone (another device). The camera is imaging controlled by the control device. The rechargeable battery is a power source of the drone.

The control unit includes the imaging control unit, the sensing unit, the calculation unit, the control condition generation unit, the control condition setting unit, and the another device information acquisition unit. The imaging control unit performs imaging control of the camera mounted on the drone. The sensing unit detects a guide light used for forming a corridor used by the drone from the image captured by the camera. The sensing unit identifies the position of the detected guide light. The another device information acquisition unit acquires position information about the another drone that uses the corridor. The calculation unit calculates the predicted arrival position of the drone at the control timing subsequent to the image capturing timing and the control target position according to the positional relationship between the drone and the guide light according to the positions of the drone and the guide light. The calculation unit calculates a distance between the another drone and the host drone. When the distance between the another drone and the host drone is less than the predetermined distance, the calculation unit sets the control target position in a direction in which the drone is away from the another drone. The control condition generation unit generates a control condition of the motor that drives the propeller of the drone according to the predicted arrival position and the control target position. For example, the control condition generation unit generates a control condition for moving the drone from the predicted arrival position toward the control target position. The control condition setting unit sets a control condition for the motor of the drone.

The control unit of the present example embodiment sets the control target position according to the positional relationship between the host drone and the another device. Therefore, according to the present example embodiment, a plurality of drones using the corridor can safely autonomously navigate according to the positional relationship with each other.

### Fourth Example Embodiment

Next, a drone according to a fourth example embodiment will be described with reference to the drawings. The drone of the present example embodiment performs navigation control according to a sound wave emitted from a guide light. The sound emitted from the guide light may be an ultrasonic wave or a sound in an audible range. The sound wave emitted from the guide light is preferably a wave in a wavelength band different from the flying sound or the environmental sound of the drone. The guide light may be provided with a directional speaker capable of emitting a sound wave having high directivity. When the directional speaker is used, a drone using a corridor can be irradiated with a sound wave having high directivity. Hereinafter, an example in which a function of performing navigation control according to a sound wave emitted from a guide light is added to the first example embodiment will be described. The function of the present example embodiment may be added to the second to third example embodiments. Hereinafter, configurations and functions similar to those of the first to third example embodiments may be omitted.

### (Configuration)

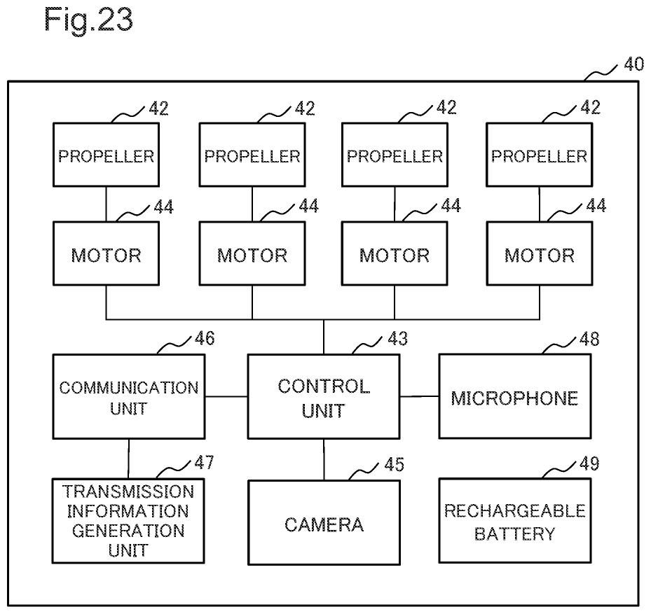

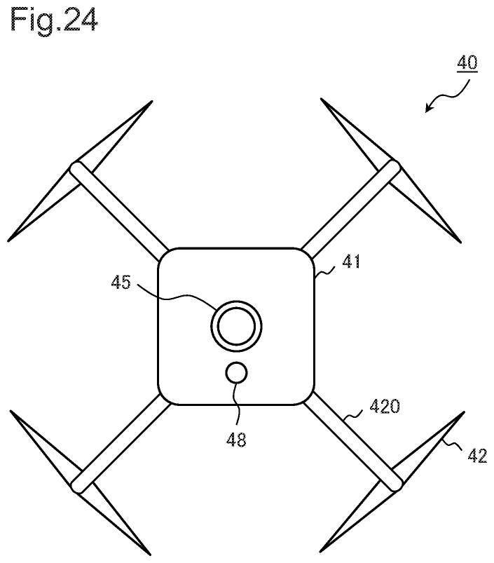

FIGS. 23 to 24 are conceptual diagrams illustrating an example of a configuration of a drone 40 according to the present example embodiment. FIG. 23 is a block diagram for describing a functional configuration of the drone 40. FIG. 24 is a bottom view of the drone 40. The upper face of the drone 40 is similar to that of the drone 10 of the first example embodiment.

The drone 40 includes a main body 41, a propeller 42, a control unit 43, a motor 44, a camera 45, a communication unit 46, a transmission information generation unit 47, a microphone 48, and a rechargeable battery 49. The control unit 43, the communication unit 46, the transmission information generation unit 47, the microphone 48, and the rechargeable battery 49 are accommodated in the main body. Most of the camera 45 except for the lens is accommodated in the main body. The drone 40 has a load carrying function (not illustrated) as in the drone 10 of the first example embodiment.

The main body 41 is a housing that accommodates the control unit 43, the camera 45, the communication unit 46, the transmission information generation unit 47, the microphone 48, the rechargeable battery 49, and the like. At least one propeller 42 for causing the drone 40 to fly is attached to the main body 41. For example, the main body 41 is provided with a space for accommodating a load therein, a mechanism for hanging a load, a place for placing a load thereon, and the like depending on the application. The shape and material of the main body 41 are not particularly limited.

The propeller 42 has a configuration similar to that of the propeller 12 of the first example embodiment. The propeller 42 is a mechanism that causes the drone 40 to fly. The propeller 42 is fixed to the main body by an arm 420. A motor 44 for rotating the propeller 42 is installed in the propeller 42. Four propellers 42 are installed in the main body of the drone 40. The rotation speeds of the plurality of propellers 42 is controlled independently of each other. The propeller 42 may be of a silent design. For example, when the width of the propeller 42 is increased or the number of the propellers 42 is increased, sufficient thrust can be acquired with a small rotation speed, so that the flying sound accompanying the rotation of the propeller 42 can be reduced.

The motor 44 has a configuration similar to that of the motor 14 of the first example embodiment. The motor 44 is installed in each of the plurality of propellers 42. The motor 44 is a drive mechanism for rotating the propeller 42. The motor 44 rotates the propeller 42 under the control of the control unit 43. The motor 44 may be of a silent design. For example, when a brushless motor is used as the motor 44, noise reduction can be improved. A vibration-proof member such as a vibration-proof rubber may be interposed at the connection portion in such a way that the vibration of the motor 44 is less likely to be transmitted to the main body (housing).

The microphone 48 receives a sound wave emitted from the guide light. Microphone 48 converts a received sound wave into an electric signal (also referred to as a sound wave signal). Microphone 48 outputs the converted sound wave signal to control unit 43. For example, the microphone 48 may selectively receive sound waves in a specific frequency band emitted from the guide light. When the frequency band of the sound wave received by the microphone 48 is limited, it is possible to prevent the sound wave emitted from the guide light from being less likely to be received due to the influence of the flying sound of the drone 40 and the environmental sound. For example, the microphone 48 may have directivity of selectively receiving a sound wave coming from a specific direction. When the microphone 48 has directivity, it is possible to selectively receive a sound wave coming from the direction of the guide light, and thus, it is possible to reduce the influence of the flying sound of the drone 40 and the environmental sound.

The control unit 43 has a configuration similar to that of the control unit 13 of the first example embodiment. The control unit 43 is a control device that controls the drone 40. The control unit 43 controls the rotation of the propeller 42. The control unit 43 controls the rotation speed of each propeller 42 by driving and controlling the motor 44 of each propeller 42. The control unit 43 performs imaging control of the camera 45. The control unit 43 causes the camera 45 to capture an image at a predetermined timing. The control unit 43 acquires an image captured by the camera 45. Furthermore, the control unit 43 acquires a sound wave signal from the microphone 48. While the drone 40 is navigating the inside of the corridor, the control unit 43 calculates a positional relationship between the drone 40 and the guide light based on an image captured by the camera 45 and a sound wave signal received by the microphone 48. The control unit 43 controls the rotation of the propeller 42 according to the calculated positional relationship. For example, the control unit 43 uses a sound wave signal as assistance of control based on an image captured by the camera 45. For example, the control unit 43 may control the rotation of the propeller 42 based only on the sound wave signal.

The camera 45 has a configuration similar to that of the camera 15 of the first example embodiment. The camera 45 is disposed to image the surroundings of the drone 40. A plurality of cameras 45 may be mounted on the drone 40 in order to image the front, the side, the upper side, and the lower side of the drone 40. The camera 45 captures an image under the control of the control unit 43. The camera 45 outputs captured image data (also referred to as an image) to the communication unit 46.

The communication unit 46 has a configuration similar to that of the communication unit 16 of the first example embodiment. The communication unit 46 receives the wireless signal transmitted from the management tower. The communication unit 46 transmits a signal including transmission information generated by the transmission information generation unit 47 and an image captured by the camera 45. Furthermore, the communication unit 46 receives a signal transmitted by another drone 40 navigating the corridor. The signal transmitted by the another drone 40 includes transmission information unique to the drone 40. The transmission information includes position information about the drone 40 that is a signal transmission source. The communication unit 46 outputs the position information included in the received transmission information to the control unit 43.

The transmission information generation unit 47 has a configuration similar to that of the transmission information generation unit 17 of the first example embodiment. The transmission information generation unit 47 generates transmission information unique to the drone 40. The transmission information includes invariable information and variation information. The transmission information generation unit 47 generates transmission information including invariable information and variation information at a predetermined cycle. The invariable information includes registration information, a manufacturing number, authentication information, and the like of the drone 40. The variation information includes position information and time. The transmission information generation unit 47 outputs the generated transmission information to the communication unit 46.

The rechargeable battery 49 has a configuration similar to that of the rechargeable battery 19 of the first example embodiment. The rechargeable battery 49 is a general secondary battery having a charging function. The rechargeable battery 49 is a power source of the drone 40.

### [Control Unit]

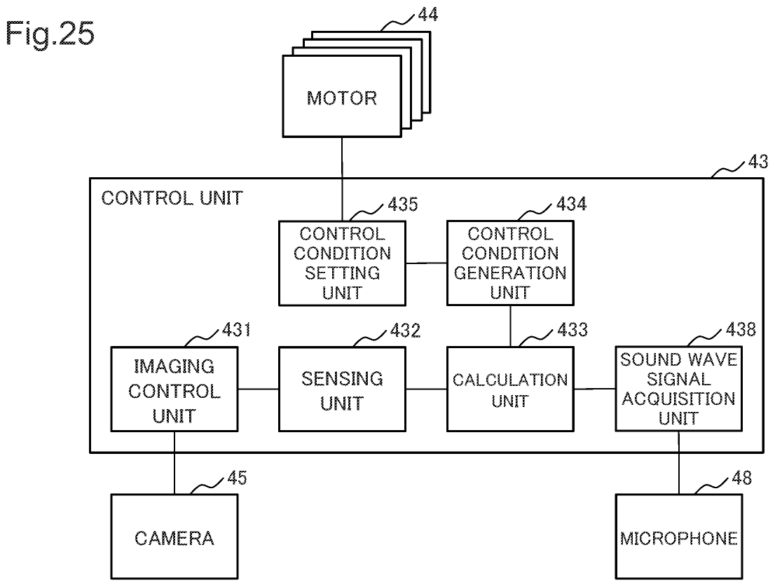

Next, the configuration of the control unit 43 mounted on the drone 40 will be described in detail. FIG. 25 is a block diagram illustrating an example of a configuration of the control unit 43. The control unit 43 includes an imaging control unit 431, a sensing unit 432, a calculation unit 433, a control condition generation unit 434, a control condition setting unit 435, and a sound wave signal acquisition unit 438.

The imaging control unit 431 has a configuration similar to that of the imaging control unit 131 of the first example embodiment. The imaging control unit 431 performs imaging control of the camera 45. The imaging control unit 431 causes the camera 45 to capture an image at a predetermined timing. The imaging control unit 431 acquires an image captured by the camera 45. The imaging control unit 431 outputs the acquired image to the sensing unit 432. In a case where an image is provided to the management side of the corridor, the imaging control unit 431 outputs the acquired image to the communication unit 46.

The sensing unit 432 has a configuration similar to that of the sensing unit 132 of the first example embodiment. The sensing unit 432 acquires an image captured by the camera 45 from the imaging control unit 431. The sensing unit 432 detects light emission of a guide light (not illustrated) from the acquired image. The sensing unit 432 extracts the light emission color of the guide light to be referred to out of the detected light emission of the guide light. For example, it is assumed that the guide light on the left bank emits green light and the guide light emits red light on the right bank. The sensing unit 432 identifies the position of the guide light or the host drone (drone 40) in the region where the corridor is formed based on the light emission of the guide light extracted from the image. The sensing unit 432 outputs the guide light extracted from the image and the position of the host drone (drone 40) to the calculation unit 433.

The sound wave signal acquisition unit 438 acquires a sound wave signal based on the sound wave emitted from the guide light from the microphone 48. The sound wave signal acquisition unit 438 outputs the acquired sound wave signal to the calculation unit 433. The sound wave signal acquisition unit 438 may filter the sound wave signal using a filter that selectively passes a frequency band of the sound wave emitted from the guide light. By filtering the sound wave signal, it is possible to reduce the disturbance due to the influence of the flying sound of the drone 40, the environmental sound, and the like. The sound wave signal acquisition unit 438 may cancel the flying sound of the drone 40 from the sound wave signal. The flying sound of the drone 40 is mainly a driving sound of the motor 44, a rotation sound of the propeller 42, a resonance sound of the main body (housing), and the like, and is characterized by a frequency band and regularity. Therefore, when the flying sound of the drone 40 is canceled from the sound wave signal according to the characteristics of the flying sound of the drone 40, the disturbance due to the influence of the flying sound of the drone 40 can be reduced.

The calculation unit 433 has a configuration similar to that of the calculation unit 133 of the first example embodiment. The calculation unit 433 acquires the positions of the guide light 440 and the host drone (drone 40) from the sensing unit 432. In a case where the host drone (drone 40) has a function of receiving a global positioning system (GPS) signal, the calculation unit 433 may acquire position information included in the GPS signal. The calculation unit 433 calculates a positional relationship between the guide light 440 and the host drone according to the acquired positions of the guide light 440 and the host drone. The calculation unit 433 calculates the position (also referred to as a predicted arrival position) of the drone 40 at the next control timing (also referred to as the next time control timing) for the drone 40, the next control timing being subsequent to the image capturing timing. The calculation unit 433 calculates a target position (also referred to as a control target position) of the drone 40 at the next time control timing. The calculation unit 433 outputs the calculated predicted arrival position and the calculated control target position to the control condition generation unit 434.

The calculation unit 433 acquires a sound wave signal related to the sound wave emitted from the guide light from the sound wave signal acquisition unit 438. The calculation unit 433 calculates the positional relationship with the guide light according to the frequency, the intensity (sound intensity), and the like of the acquired sound wave signal. The sound intensity is an energy amount of a sound wave per unit area/unit time.

For example, in a case where the guide light to which the drone 40 refers continuously emits sound waves of the same frequency with the same intensity, the frequency of the sound wave received by the microphone 48 changes due to the Doppler effect. As the drone 40 approaches the guide light, the microphone 48 receives a sound wave having a higher frequency than the sound wave emitted by the guide light. At the timing when the drone 40 comes closest to the guide light, the microphone 48 receives a sound wave having the same height as the sound wave emitted by the guide light. As the drone 40 moves away from the guide light, the microphone 48 receives a sound wave having a lower frequency than the sound wave emitted by the guide light. That is, the positional relationship with the guide light can be grasped according to the frequency of the sound wave received by the microphone 48. The corridor that the drone 40 navigates is formed by a plurality of guide lights. Therefore, the drone 40 navigating the corridor can grasp the positional relationship of the guide lights according to the change in the frequency of the sound waves emitted from the plurality of guide lights.

For example, when the guide light to which the drone 40 refers continues to emit sound waves of the same frequency with the same intensity, the intensity (sound intensity) of the sound wave received by the microphone 48 changes according to the distance to the guide light. As the drone 40 approaches the guide light, the sound intensity of the sound wave received by the microphone 48 gradually increases. At the timing when the drone 40 comes closest to the guide light, the sound intensity of the sound wave to be received is maximum. As the drone 40 moves away from the guide light, the sound intensity of the sound wave to be received gradually decreases. That is, the positional relationship with the guide light can be grasped according to the sound intensity of the sound wave received by the microphone 48. The corridor that the drone 40 navigates is formed by a plurality of guide lights. Therefore, the drone 40 navigating the corridor can grasp the positional relationship of the guide lights according to the change in the sound intensity emitted from the plurality of guide lights. For example, when a sound wave having high directivity is emitted from the guide light toward the corridor, the drone 40 can be more accurately guided.

The calculation unit 433 calculates a positional relationship between the drone 40 and the guide light according to a change in the frequency of the sound wave signal and the sound intensity. For example, when the distance between the drone 40 and the guide light is less than the minimum designated distance, the calculation unit 433 calculates the control target position in a direction in which the drone is away from the guide light. For example, in a case where the distance between the drone 40 and the guide light is equal to or greater than the maximum designated distance, the calculation unit 433 calculates the control target position in a direction in which the drone approaches the guide light. The calculation unit 433 outputs the calculated predicted arrival position and the calculated control target position to the control condition generation unit 434.

The control condition generation unit 434 has a configuration similar to that of the control condition generation unit 134 of the first example embodiment. The control condition generation unit 434 acquires the predicted arrival position and the control target position calculated by the calculation unit 433. The control condition generation unit 434 generates a control condition for controlling the drone 40 from the predicted arrival position toward the control target position. The control condition generation unit 434 calculates the traveling direction/speed of the drone 40 from the predicted arrival position according to the control target position. The control condition generation unit 434 sets the rotation speeds of the plurality of propellers 42 according to the traveling direction/speed. The control condition generation unit 434 outputs the generated control condition to the control condition setting unit 435.

The control condition setting unit 435 has a configuration similar to that of the control condition setting unit 135 of the first example embodiment. The control condition setting unit 435 acquires the control condition from the control condition generation unit 434. The control condition setting unit 435 sets the control condition for the motor 44 at the next time control timing. The rotation speed of each propeller 42 is controlled by driving the motor 44 according to the control condition. As a result, the drone 40 travels in a direction/speed according to the control condition.

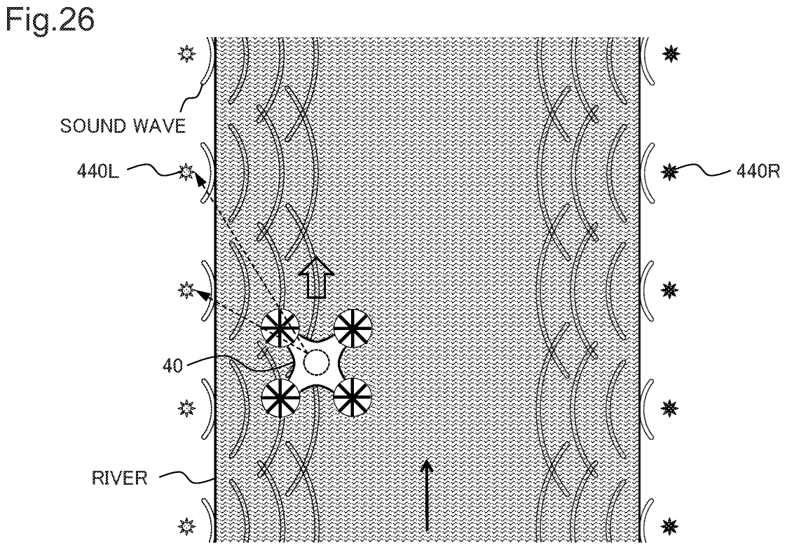

FIG. 26 is a conceptual diagram for describing an example of control of the drone 40. In FIG. 26, the river flows from the bottom (upstream) to the top (downstream) of the paper surface. The drone 40 navigates the inside of the corridor according to the light emission/sound wave of the guide light 440L installed on the left bank (left side of the paper surface) of the river. The drone 40 may navigate the inside of the corridor according to the light emission/sound wave of the guide light 440R installed on the right bank (right side of the paper surface) of the river. In FIG. 26, a corridor is omitted. For example, the guide light 440L and the guide light 440R emit sound waves of different frequencies. For example, the guide light 440L and the guide light 440R emit sound waves of different timbre. For example, the configuration may be such that the guide light 440L and the guide light 440R receive the flying sound of the drone 40, and the navigation state of the drone 40 navigating the corridor is identified on the management side of the corridor according to the received flying sound. For example, the management side receives the flying sound of the drone 40 and identifies the position of the drone 40. The management side can manage the drone 40 navigating the corridor according to the identified position of the drone.

### (Operation)

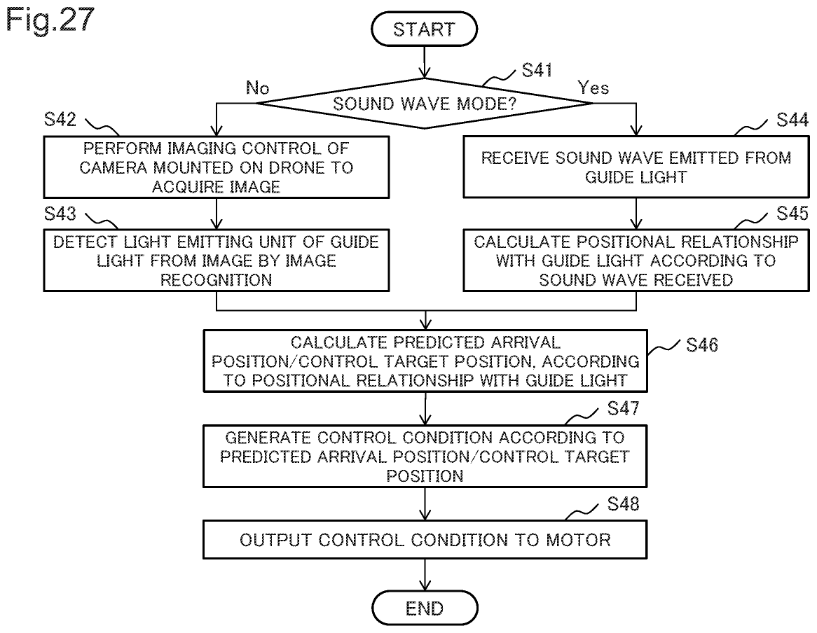

Next, an example of the operation of the control unit 43 mounted on the drone 40 of the present example embodiment will be described with reference to the drawings. FIG. 27 is a flowchart for describing an example of the operation of the control unit 43. Hereinafter, an example in which a normal mode in which control is performed using an image captured by the camera 45 and a sound wave mode in which control is performed using a sound wave received by the microphone 48 are separately performed will be described. The normal mode and the sound wave mode may be used in combination. Hereinafter, the control unit 43 will be described as an operation subject.

In FIG. 27, in a case where the mode is not the sound wave mode (Yes in step S41), the control unit 43 performs imaging control of the camera 45 mounted on the drone 40 to acquire an image (step S42). The image captured by the camera 45 includes a guide light installed on the bank of the river.

Next, the control unit 43 detects the light emitting unit of the guide light to be referred to by image recognition from the image captured by the camera 45 (step S43).

In the case of the sound wave mode in step S41 (Yes in step S41), the control unit 43 receives the sound wave emitted from the guide light (step S44).

Next, the control unit 43 calculates a positional relationship between the drone 40 and the guide light according to the received sound wave (step S45).

After step S43 or step S45, the control unit 43 calculates the predicted arrival position/the control target position according to the positional relationship between the drone 40 and the guide light (step S46).

Next, the control unit 43 generates a control condition according to the calculated predicted arrival position/control target position (step S47). The control unit 43 generates a control condition for the drone 40 to move from the predicted arrival position toward the control target position.

Next, the control unit 43 outputs the generated control condition to the motor 44 (step S48). When the motor 44 is driven according to the control condition, the drone 40 can navigate the inside of the designation range set inside the corridor. When the use of the corridor is continued, the process returns to step S41 after step S48.

As described above, the drone of the present example embodiment includes the main body, the propeller, the motor, the transmission information generation unit, the communication unit, the camera, the rechargeable battery, the microphone, and the control unit (control device). The motor is driven and controlled by a control device. The propeller is rotatably mounted on the main body via an arm. The propeller rotates in response to driving of the motor. The transmission information generation unit generates transmission information including identification information and position information about the host drone. The communication unit communicates with a management device that manages the corridor. The communication unit transmits the transmission information to the management device. The camera is imaging controlled by the control device. The microphone receives a sound wave emitted from a guide light used to form a corridor. The rechargeable battery is a power source of the drone.

The control unit includes the imaging control unit, the sensing unit, the calculation unit, the control condition generation unit, the control condition setting unit, and the sound wave signal acquisition unit. The imaging control unit performs imaging control of the camera mounted on the drone. The sensing unit detects a guide light used for forming a corridor used by the drone from the image captured by the camera. The sensing unit identifies the position of the detected guide light. The sound wave signal acquisition unit acquires a sound wave signal related to a sound wave emitted from the guide light. The calculation unit calculates the predicted arrival position of the drone at the control timing subsequent to the image capturing timing and the control target position according to the positional relationship between the drone and the guide light according to the positions of the drone and the guide light. The calculation unit calculates a positional relationship with the guide light by using the acquired sound wave signal. For example, the calculation unit calculates the distance to the guide light according to the frequency of the acquired sound wave signal. For example, the calculation unit calculates the distance to the guide light according to the sound intensity of the acquired sound wave signal. The control condition generation unit generates a control condition of the motor that drives the propeller of the drone according to the predicted arrival position and the control target position. For example, the control condition generation unit generates a control condition for moving the drone from the predicted arrival position toward the control target position. The control condition setting unit sets a control condition for the motor of the drone.

The control unit of the present example embodiment can perform navigation control of the drone according to the sound wave received by the microphone mounted on the drone. Therefore, according to the present example embodiment, autonomous navigation of the drone can be achieved even in a situation where visibility is poor. In the present example embodiment, the example of guiding the drone using the sound wave is described, but the drone may be guided using a radio wave (radar) or a light beam (laser). For example, it is possible to irradiate the corridor with radar/laser from above a bridge in the traveling direction of the drone and guide the drone navigating the inside of the corridor to an appropriate navigation route in a manner of guiding the aircraft to land. From above the bridge across the river, it is easy to irradiate the drone with radar/laser along the traveling direction of the drone. In this case, since the laser has higher directivity than the radar, it is easy to aim at the drone. For example, a guidance radio wave including ID information (RID) of a specific drone may be emitted from a guide light or a management tower toward the corridor to guide the specific drone having the same RID. When the guidance radio wave including the RID is used, the drone to be guided can be guided regardless of the directivity of the radio wave. For example, when the guidance radio wave is used, the drone that is likely to deviate from the corridor can be guided to the inside of the corridor or toward the guide light/management tower. For example, when the guidance radio wave is used, it is possible to perform control to guide a drone that illegally uses the corridor to the outside of the corridor or toward a guide light/management tower, or control to cause the drone to fall into a river.

### Fifth Example Embodiment

Next, a management device according to a fifth example embodiment will be described with reference to the drawings. The management device of the present example embodiment transmits guidance information for guiding the drones navigating the inside of the corridor in an appropriate positional relationship to the drones. The management device of the present example embodiment manages navigation of the drones according to the first to fourth example embodiments in the corridor to be managed.

### [Management Device]

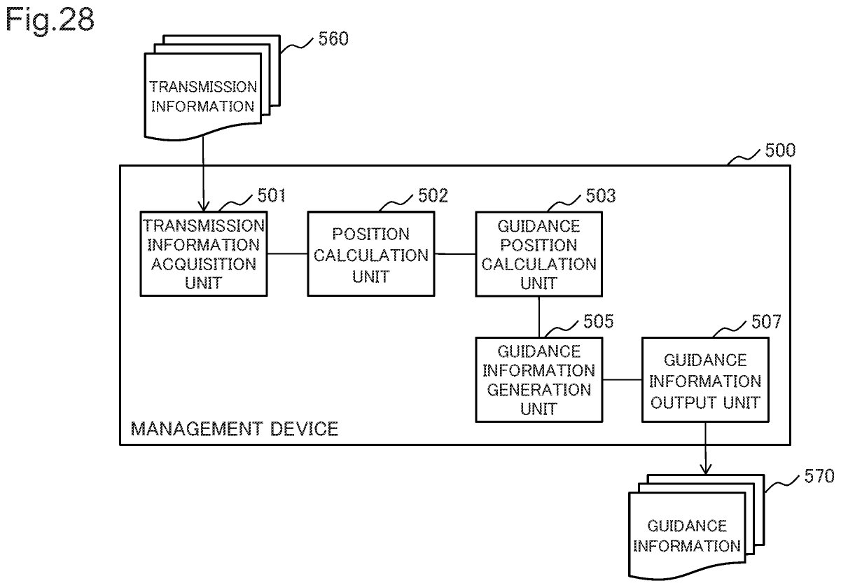

FIG. 28 is a block diagram illustrating an example of a configuration of a management device 500. The management device 500 includes a transmission information acquisition unit 501, a position calculation unit 502, a guidance position calculation unit 503, a guidance information generation unit 505, and a guidance information output unit 507. For example, the management device 500 is constructed in a cloud or a server (not illustrated). For example, the management device 500 may be disposed in a guide light or a management tower used to form a corridor.

The transmission information acquisition unit 501 acquires transmission information 560 of a plurality of drones using the corridor from the management tower (not illustrated) disposed in the vicinity of the corridor. The transmission information acquisition unit 501 extracts time (transmission time) and position information included in the transmission information 560. The transmission information acquisition unit 501 outputs the extracted transmission time and position information to the position calculation unit 502. The use of information other than the transmission time and the position information is not particularly limited.

The position calculation unit 502 acquires, from the transmission information acquisition unit 501, transmission times and position information about a plurality of drones using the corridor. The position calculation unit 502 calculates the positions of the plurality of drones using the acquired position information. For example, the position calculation unit 502 calculates the positions of a plurality of drones at the transmission time. For example, the position calculation unit 502 calculates the positions of the plurality of drones at a time point after a predetermined time has elapsed from the transmission time. For example, the position calculation unit 502 calculates the positions of the plurality of drones at the time when guidance information 570 generated based on the transmission time is received by the plurality of drones navigating the corridor. For example, the position calculation unit 502 calculates the positions of the plurality of drones at the time when the guidance information 570 is received based on the position changes and speeds of the plurality of drones calculated so far. The position calculation unit 502 outputs the calculated positions of the plurality of drones to the guidance position calculation unit 503.

The guidance position calculation unit 503 acquires the positions of the plurality of drones calculated by the position calculation unit 502. The guidance position calculation unit 503 calculates guidance positions of the plurality of drones inside the corridor based on the acquired positional relationships between the plurality of drones. For example, the guidance position calculation unit 503 calculates positions to guide the plurality of drones according to the positions of the plurality of drones at the time when the guidance information 570 is received. For example, when ranges (also referred to as occupation ranges) set for the plurality of drones overlap each other at the reception time of the guidance information 570, positions where the occupation ranges do not overlap each other are calculated as guidance positions. For example, the occupation range is set to a range of a sphere or a circle centered on the drone. The guidance position calculation unit 503 outputs the calculated guidance positions of the plurality of drones to the guidance information generation unit 505.

The guidance information generation unit 505 acquires the guidance position calculated by the guidance position calculation unit 503. The guidance information generation unit 505 generates the guidance information 570 including control conditions for individual drones by using the acquired guidance positions of the plurality of drones. The control condition included in the guidance information 570 is information for controlling the directions and speeds of the plurality of drones. For drones whose occupation ranges at the reception time of the guidance information 570 overlap each other, the guidance information generation unit 505 generates the guidance information 570 for performing control in such a way as to move the positions of the drones away from each other. In a case where there is no drone whose occupation range at the reception time of the guidance information overlaps with each other, the guidance information generation unit 505 does not generate the guidance information 570 of those drones. For example, even in a case where there is no drone whose occupation range at the reception time of the guidance information overlaps with each other, the guidance information generation unit 505 may generate the guidance information 570 for performing control in such a way that the positions of the drones do not approach each other.

The guidance information generation unit 505 may generate the guidance information 570 about a plurality of drones using a machine training method. For example, a model that outputs the guidance information 570 for disposing a plurality of drones in an appropriate positional relationship is generated in response to inputs of position information about a plurality of drones navigating the inside of the corridor. By using such a model, calculation by the guidance position calculation unit 503 can be omitted. Details of the model that outputs the guidance information 570 in response to the inputs of the position information about the plurality of drones will not be described.

The guidance information output unit 507 outputs the guidance information 570 generated by the guidance information generation unit 505 to the management tower. In a case where the management device 500 is disposed in the vicinity of the corridor, the configuration may be such that the guidance information 570 is transmitted from the management device 500 to the drone navigating the corridor. For example, the management device 500 may be disposed in a management tower or a guide light.

### [Drone]

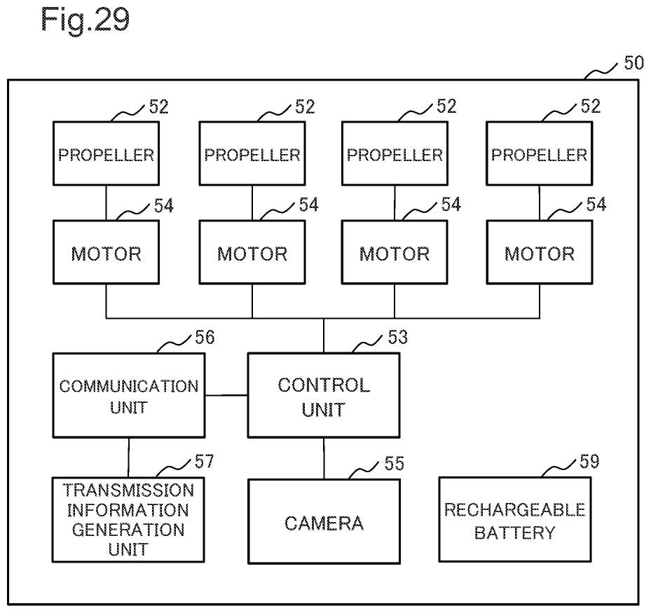

FIG. 29 is a conceptual diagram illustrating an example of a configuration of a drone 50 that uses a corridor to be managed by the management device 500 according to the present example embodiment. FIG. 29 is a block diagram for describing a functional configuration of the drone 50. The drone 50 has an appearance similar to that of the drone 10 of the first example embodiment. The drone 50 may have an appearance/function similar to that of the drone 40 of the fourth example embodiment.

Drone 50 includes a main body (not illustrated), a propeller 52, a control unit 53, a motor 54, a camera 55, a communication unit 56, a transmission information generation unit 57, and a rechargeable battery 59. The control unit 53, the communication unit 56, the transmission information generation unit 57, and the rechargeable battery 59 are accommodated in the main body. Most of the camera 55 except for the lens is accommodated in the main body. The drone 50 has a load carrying function (not illustrated) as in the drone 10 of the first example embodiment.

The propeller 52 has a configuration similar to that of the propeller 12 of the first example embodiment. The propeller 52 is a mechanism that causes the drone 50 to fly. The propeller 52 is fixed to the main body by an arm (not illustrated). A motor 54 for rotating the propeller 52 is installed in the propeller 52. Four propellers 52 are installed in the main body of the drone 50. The rotation speeds of the plurality of propellers 52 is controlled independently of each other.

The motor 54 has a configuration similar to that of the motor 14 of the first example embodiment. The motor 54 is installed in each of the plurality of propellers 52. The motor 54 is a drive mechanism for rotating the propeller 52. The motor 54 rotates the propeller 52 under the control of the control unit 53.

The control unit 53 has a configuration similar to that of the control unit 13 of the first example embodiment. The control unit 53 is a control device that controls the drone 50. The control unit 53 controls the rotation of the propeller 52. The control unit 53 controls the rotation speed of each propeller 52 by driving and controlling the motor 54 of each propeller 52. The control unit 53 performs imaging control off the camera 35. The control unit 53 causes the camera 55 to capture an image at a predetermined timing. The control unit 53 acquires an image captured by the camera 55. The control unit 53 controls the rotation of the propeller 52 based on the position of the guide light included in the image captured by the camera 55 while the drone 50 is navigating the inside of the corridor. The control unit 53 controls the rotation of the propeller 52 in such a way that the drone 50 navigates an appropriate position according to the position of the guide light that emits light in a color to be referred to.

The control unit 53 acquires the guidance information 570 transmitted from the management device 500 from the communication unit 56. When acquiring the guidance information 570, the control unit 53 controls the rotation of the propeller 52 according to the guidance information.

The camera 55 has a configuration similar to that of the camera 15 of the first example embodiment. The camera 55 is disposed to image the surroundings of the drone 50. A plurality of cameras 55 may be mounted on the drone 50 in order to image the front, the side, the upper side, and the lower side of the drone 50. The camera 55 captures an image under the control of the control unit 53. The camera 55 outputs captured image data (also referred to as an image) to the communication unit 56.

The communication unit 56 has a configuration similar to that of the communication unit 16 of the first example embodiment. The communication unit 56 receives the wireless signal transmitted from the management tower. The wireless signal transmitted from the management tower includes the guidance information 570. The communication unit 56 transmits a signal including transmission information generated by the transmission information generation unit 57 and an image captured by the camera 55. The communication unit 56 outputs the received guidance information 570 to control unit 53.

The transmission information generation unit 57 has a configuration similar to that of the transmission information generation unit 17 of the first example embodiment. The transmission information generation unit 57 generates transmission information unique to the drone 50. The transmission information includes invariable information and variation information. The transmission information generation unit 57 generates transmission information including invariable information and variation information at a predetermined cycle. The invariable information includes registration information, a manufacturing number, authentication information, and the like of the drone 50. The variation information includes position information and time. The transmission information generation unit 57 outputs the generated transmission information to the communication unit 56.

The rechargeable battery 59 has a configuration similar to that of the rechargeable battery 19 of the first example embodiment. The rechargeable battery 59 is a general secondary battery having a charging function. The rechargeable battery 59 is a power source of the drone 50.

### [Control Unit]

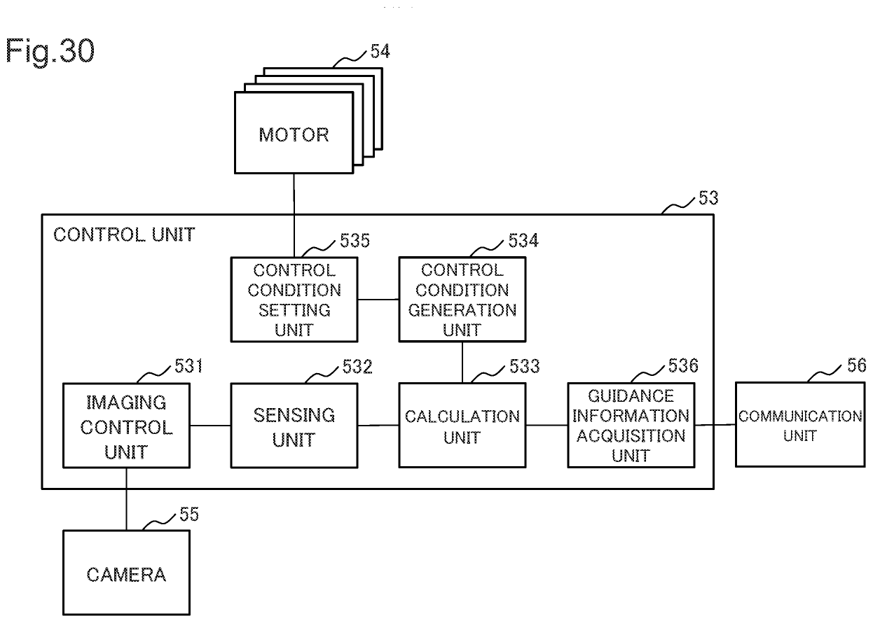

Next, the configuration of the control unit 53 mounted on the drone 50 will be described in detail. FIG. 30 is a block diagram illustrating an example of a configuration of the control unit 53. The control unit 53 includes an imaging control unit 531, a sensing unit 532, a calculation unit 533, a control condition generation unit 534, a control condition setting unit 535, and a guidance information acquisition unit 536.

The imaging control unit 531 has a configuration similar to that of the imaging control unit 131 of the first example embodiment. The imaging control unit 531 performs imaging control of the camera 55. The imaging control unit 531 causes the camera 55 to capture an image at a predetermined timing. The imaging control unit 531 acquires an image captured by the camera 55. The imaging control unit 531 outputs the acquired image to the sensing unit 532. In a case where an image is provided to the management side of the corridor, the imaging control unit 531 outputs the acquired image to the communication unit 56.

The sensing unit 532 has a configuration similar to that of the sensing unit 132 of the first example embodiment. The sensing unit 532 acquires an image captured by the camera 55 from the imaging control unit 531. The sensing unit 532 detects light emission of a guide light (not illustrated) from the acquired image. The sensing unit 532 extracts the light emission color of the guide light to be referred to out of the detected light emission of the guide light. For example, it is assumed that the guide light on the left bank emits green light and the guide light emits red light on the right bank. The sensing unit 532 identifies the position of the guide light or the host drone (drone 50) in the region where the corridor is formed based on the light emission of the guide light extracted from the image. The sensing unit 532 outputs the guide light extracted from the image and the position of the host drone (drone 50) to the calculation unit 533.

The calculation unit 533 has a configuration similar to that of the calculation unit 133 of the first example embodiment. The calculation unit 533 acquires the positions of a guide light 540 and the host drone (drone 50) from the sensing unit 532. In a case where the host drone (drone 50) has a function of receiving a global positioning system (GPS) signal, the calculation unit 533 may acquire position information included in the GPS signal. The calculation unit 533 calculates a positional relationship between the guide light 540 and the host drone according to the acquired positions of the guide light 540 and the host drone. The calculation unit 533 calculates the position (also referred to as a predicted arrival position) of the drone 50 at the next control timing (also referred to as the next time control timing) for the drone 50, the next control timing being subsequent to the image capturing timing. The calculation unit 533 calculates a target position (also referred to as a control target position) of the drone 50 at the next time control timing. The calculation unit 533 outputs the calculated predicted arrival position and the calculated control target position to the control condition generation unit 534.

The guidance information acquisition unit 536 acquires the guidance information 570 transmitted from the management device 500 from the communication unit 56. The guidance information acquisition unit 536 outputs the acquired guidance information 570 to the control condition generation unit 534.

The control condition generation unit 534 has a configuration similar to that of the control condition generation unit 134 of the first example embodiment. The control condition generation unit 534 acquires the predicted arrival position and the control target position calculated by the calculation unit 533. The control condition generation unit 534 generates a control condition for controlling the drone 50 from the predicted arrival position toward the control target position. The control condition generation unit 534 calculates the traveling direction/speed of the drone 50 from the predicted arrival position according to the control target position. The control condition generation unit 534 sets the rotation speeds of the plurality of propellers 52 according to the traveling direction/speed. The control condition generation unit 534 outputs the generated control condition to the control condition setting unit 535.

The control condition generation unit 534 acquires the guidance information 570 transmitted from the management device 500 from the guidance information acquisition unit 536. When the guidance information 570 is acquired, the control condition generation unit 534 outputs the control condition included in the acquired guidance information 570 to the control condition setting unit 535.

The control condition setting unit 535 has a configuration similar to that of the control condition setting unit 135 of the first example embodiment. The control condition setting unit 535 acquires the control condition from the control condition generation unit 534. The control condition setting unit 535 sets the control condition for the motor 54 at the next time control timing. The rotation speed of each propeller 52 is controlled by driving the motor 54 according to the control condition. As a result, the drone 50 travels in a direction/speed according to the control condition.

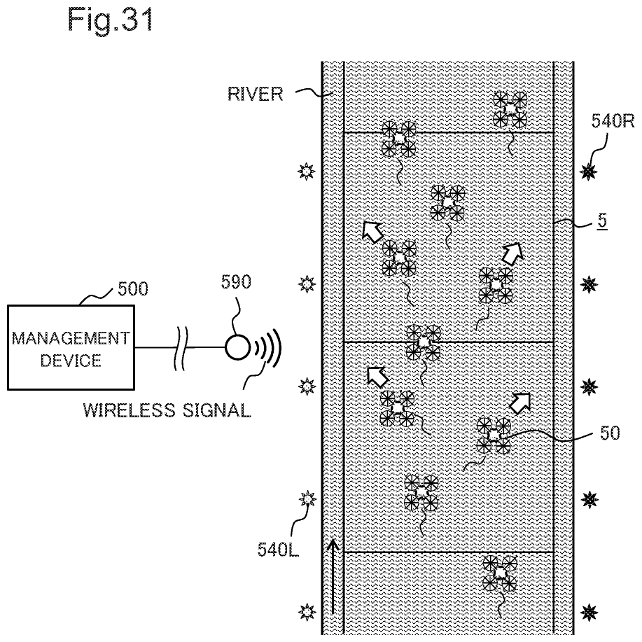

FIG. 31 is a conceptual diagram for describing an example of control of the drone 50. In FIG. 31, the river flows from the bottom (upstream) to the top (downstream) of the paper surface. The drone 50 navigates the inside of a corridor 5 according to the light emission of the guide light 540L installed on the left bank (left side of the paper surface) of the river. The drone 50 may navigate the inside of the corridor 5 according to the light emission of the guide light 540R installed on the right bank (right side of the paper surface) of the river. FIG. 31 illustrates the management device 500 and a management tower 590. The management device 500 and the management tower 590 are connected via an Internet line or a wireless communication network. The management tower 590 receives transmission information about the drone 50 navigating the corridor 5. The management tower 590 transmits the guidance information 570 received from the management device 500 to each of the plurality of drones 50 via a wireless signal.

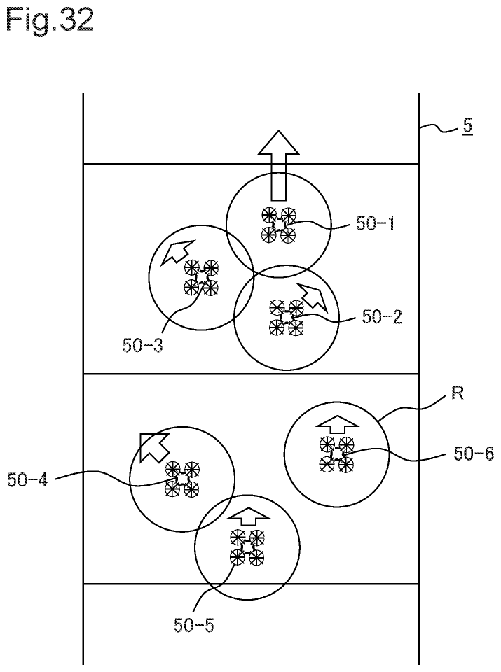

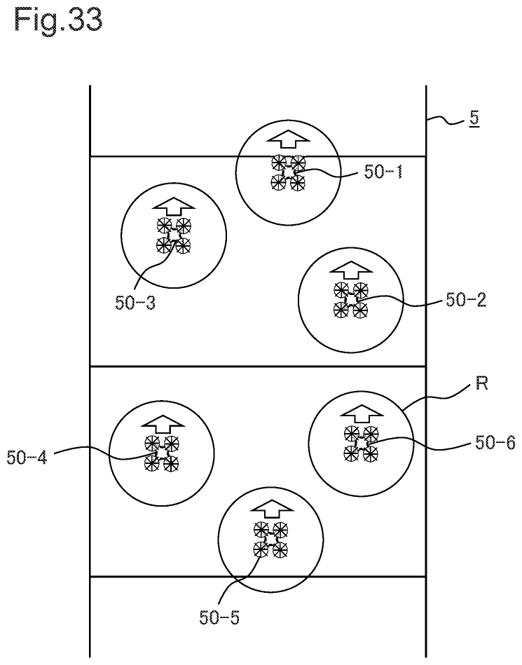

FIGS. 32 to 33 are conceptual diagrams for describing an example of control of the drone 50. FIGS. 32 to 33 are views of the corridor 5 when viewed from above. The drones 50-1 to 50-6 using the corridor 5 move upward from the lower side of the paper surface. The occupation range R is set around the drone 50. The occupation range R is a range of a sphere or a circle centered on each of the plurality of drones 50. The occupation range R is set to a size in which a plurality of drones 50 navigating the corridor 5 is less likely to collide with each other. The occupation range R may be set to the same size or different sizes with respect to the plurality of drones 50. For example, the occupation range R is set according to the size of the drone 50. For example, the occupation range R is set according to the importance of the cargo carried by the drone 50. For example, the occupation range R is set according to the speed of the drone 50. In FIGS. 32 to 33, the occupation range R is indicated by a solid circle. In the examples of FIGS. 32 to 33, the difference in speed between the drones 50 is indicated by the length of an arrow. The longer the arrow, the faster the speed, and the shorter the arrow, the slower the speed.

In the example of FIG. 32, six drones 50-1 to 50-6 are navigating a corridor. In the scene of FIG. 32, the occupation ranges R of the drones 50-1 to 50-3 overlap. The occupation ranges R of the drones 50-4 to 50-5 also overlap. In such a case, the management device 500 generates the guidance information 570 for the drones 50-1 to 50-5. The management device 500 does not generate the guidance information 570 for the drone 50-6 whose occupation range R do not overlap with others. The management device 500 generates the guidance information 570 in such a way that the occupation ranges R of the drones 50-1 to 50-5 do not overlap.

In the example of FIG. 32, the management device 500 generates the guidance information 570 for increasing the speed of the drone 50-1. The management device 500 generates the guidance information 570 for moving the drone 50-2 leftward and forward. The management device 500 generates the guidance information 570 for moving the drone 50-3 rightward and forward. The management device 500 generates the guidance information 570 for moving the drone 50-4 leftward and forward. The management device 500 generates the guidance information 570 for decelerating the drone 50-5. The management device 500 does not generate the guidance information 570 for the drone 50-6.

In the example of FIG. 32, the drones 50-1 to 50-5 that have received the guidance information 570 generated by the management device 500 are controlled in accordance with the guidance information 570. The drone 50-1 increases the speed according to the guidance information 570. The drone 50-2 moves leftward and forward according to the guidance information 570. The drone 50-3 moves rightward and forward in accordance with the guidance information 570. The drone 50-4 moves leftward and forward according to the guidance information 570. The drone 50-5 is decelerated according to the guidance information 570. The drone 50-6 continues autonomous control.

The scene of FIG. 33 is a situation as a result of guiding the drones 50-1 to 50-5 after the scene of FIG. 32. As a result of the above guidance, as illustrated in FIG. 33, overlapping of the occupation ranges R of the drones 50-1 to 50-6 is eliminated.

### (Operation)

Next, an example of operations of the management device 500 of the present example embodiment and the control unit 53 mounted on the drone 50 using the corridor to be managed by the management device 500 will be described with reference to the drawings. Hereinafter, the operations of the management device 500 and the control unit 53 will be individually described.

### [Management Device]

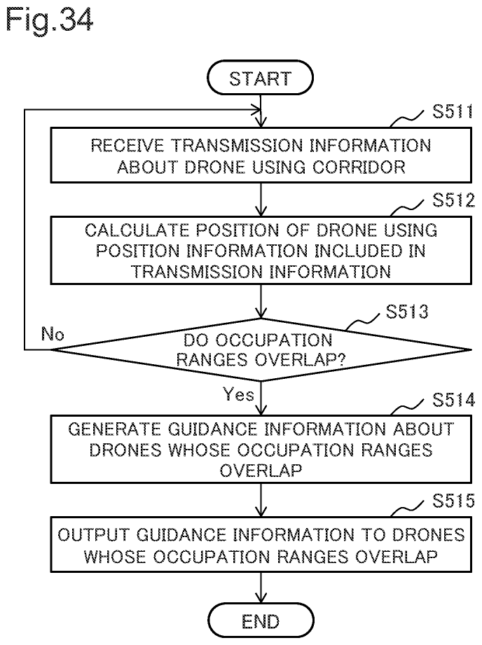

FIG. 34 is a flowchart for describing the operation of the management device 500. In the description along the flowchart of FIG. 34, the management device 500 will be described as an operation subject.

In FIG. 34, first, the management device 500 receives transmission information about the drone 50 that is using the corridor 5 (step S511). The management device 500 receives transmission information about the drone 50 using the corridor 5 via the management tower 590.

Next, the management device 500 calculates the position of the drone 50 that is using the corridor 5 by using the position information included in the transmission information (step S512).

When the occupation ranges R overlap each other (Yes in step S513), the management device 500 generates the guidance information 570 for the drones 50 whose occupation ranges R overlap each other (step S514). When there is no overlap in the occupation range R (No in step S513), the process returns to step S511.

After step S514, the guidance information 570 is output to the drone 50 whose occupation ranges overlap (step S515). When the management of the corridor 5 is continued, the process returns to step S511.

### [Control Unit]

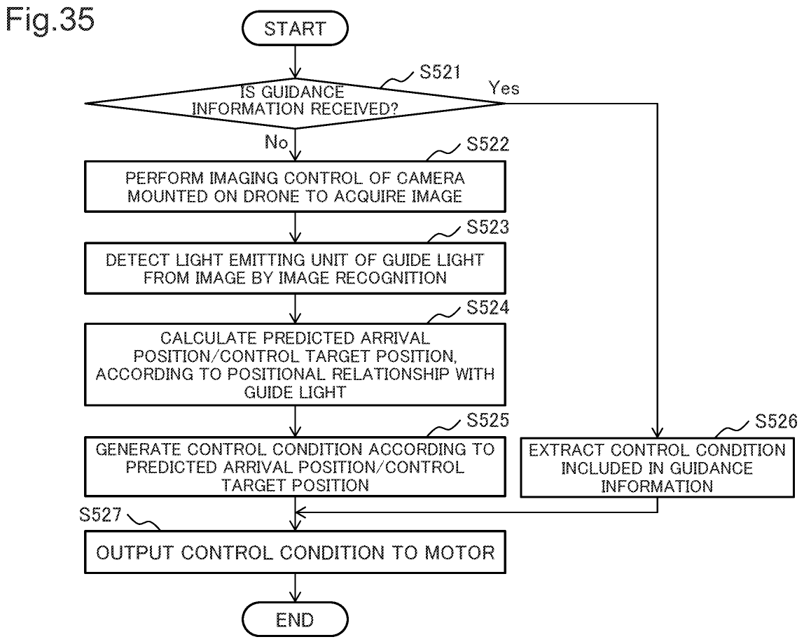

FIG. 35 is a flowchart for describing an example of the operation of the control unit 53. In the description along the flowchart of FIG. 35, the control unit 53 will be described as an operation subject.

In FIG. 35, when the guidance information 570 has not been received (No in step S521), the control unit 53 performs imaging control of the camera 55 mounted on the drone 50 to acquire an image (step S521). The image captured by the camera 55 includes the guide light 540 installed on the bank of the river.

Next, the control unit 53 detects the light emitting unit of the guide light 540 to be referred to by image recognition from the image captured by the camera 55 (step S523).

Next, the control unit 53 calculates a positional relationship between the drone 50 and the guide light 540 (step S524). For example, the control unit 53 calculates the distance between the drone 50 and the guide light 540 as the positional relationship between the guide light 540 and the drone 50.

Next, the control unit 53 calculates the predicted arrival position/the control target position according to the positional relationship between the drone 50 and the guide light 540 (step S524).

Next, the control unit 53 generates a control condition according to the calculated predicted arrival position/control target position (step S525). The control unit 53 generates a control condition for the drone 50 to move from the predicted arrival position toward the control target position.

When the guidance information 570 is received in step S521 (Yes in step S521), the control unit 53 extracts a control condition included in the guidance information 570 (step S526).

After step S525 or step S526, the control unit 53 outputs the generated control condition to the motor 54 (step S527. When the motor 54 is driven according to the control condition, the drone 50 can navigate the inside of the designation range set inside the corridor 5. When the use of the corridor is continued, the process returns to step S521 after step S527.

As described above, the management device according to the present example embodiment includes the transmission information acquisition unit, the position calculation unit, the guidance position calculation unit, the guidance information generation unit, and the guidance information output unit. The transmission information acquisition unit acquires transmission information transmitted by a drone using a corridor. The position calculation unit calculates the position of the drone by using the position information included in the transmission information. The guidance position calculation unit calculates guidance positions of the plurality of drones inside the corridor based on positional relationships between the plurality of drones. The guidance information generation unit generates guidance information including control conditions for individual drones by using the guidance positions of the plurality of drones. The guidance information output unit outputs the generated guidance information.

The drone that uses a corridor to be managed by a management device according to the present example embodiment includes the main body, the propeller, the motor, the transmission information generation unit, the communication unit, the camera, the rechargeable battery, and the control unit (control device). The motor is driven and controlled by a control device. The propeller is rotatably mounted on the main body via an arm. The propeller rotates in response to driving of the motor. The transmission information generation unit generates transmission information including identification information and position information about the host drone. The communication unit communicates with a management device that manages the corridor. The communication unit transmits the transmission information to the management device. The camera is imaging controlled by the control device. The rechargeable battery is a power source of the drone.

The control unit includes the imaging control unit, the sensing unit, the calculation unit, the control condition generation unit, the control condition setting unit, and the guidance information acquisition unit. The imaging control unit performs imaging control of the camera mounted on the drone. The sensing unit detects a guide light used for forming a corridor used by the drone from the image captured by the camera. The sensing unit identifies the position of the detected guide light. The calculation unit calculates the predicted arrival position of the drone at the control timing subsequent to the image capturing timing and the control target position according to the positional relationship between the drone and the guide light according to the positions of the drone and the guide light. The guidance information acquisition unit acquires guidance information including the control condition generated by a management device that manages a corridor. The control condition generation unit generates a control condition of the motor that drives the propeller of the drone according to the predicted arrival position and the control target position. The control condition generation unit outputs the control condition included in the guidance information to the control condition setting unit in response to the acquisition of the guidance information. The control condition setting unit sets a control condition for the motor of the drone.

The management device according to the present example embodiment generates guidance information for guiding a drone using a corridor. The drone that uses a corridor autonomously navigates according to the position of a guide light in normal times. Further, when the guidance information is acquired, the drone using the corridor is guided according to the guidance information. Therefore, according to the present example embodiment, it is possible to achieve both the autonomous navigation of the drone using the corridor and the navigation guided from the outside.

### Sixth Example Embodiment

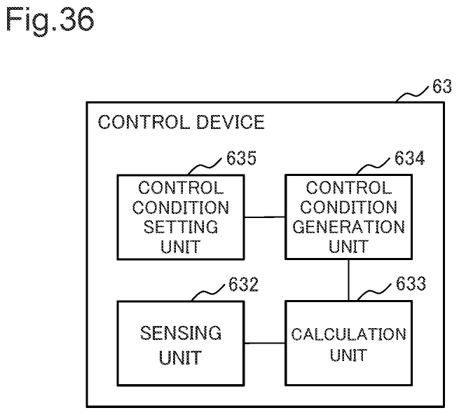

Next, a control device according to a sixth example embodiment will be described with reference to the drawings. The control device of the present example embodiment has a configuration in which the control unit mounted on the drone of the first to fifth example embodiments is simplified. FIG. 36 is a block diagram illustrating an example of a configuration of a control device 63 according to the present example embodiment. The control device 63 includes a sensing unit 632, a calculation unit 633, a control condition generation unit 634, and a control condition setting unit 635.

The sensing unit 632 detects a guide light used for forming a corridor used by the drone from an image captured by a camera mounted on the drone. The sensing unit 632 identifies the position of the detected guide light. The calculation unit 633 calculates the predicted arrival position of the drone at the control timing subsequent to the image capturing timing and the control target position according to the positional relationship between the drone and the guide light according to the positions of the drone and the guide light. The control condition generation unit 634 generates a control condition of the motor that drives the propeller of the drone according to the predicted arrival position and the control target position. The control condition setting unit 635 sets a control condition for the motor of the drone.

As described above, according to the present example embodiment, the autonomous navigation of the drone using the corridor can be achieved by setting the control condition for the motor of the drone according to the position of the guide light detected from the image captured by the camera mounted on the drone.

### (Hardware)

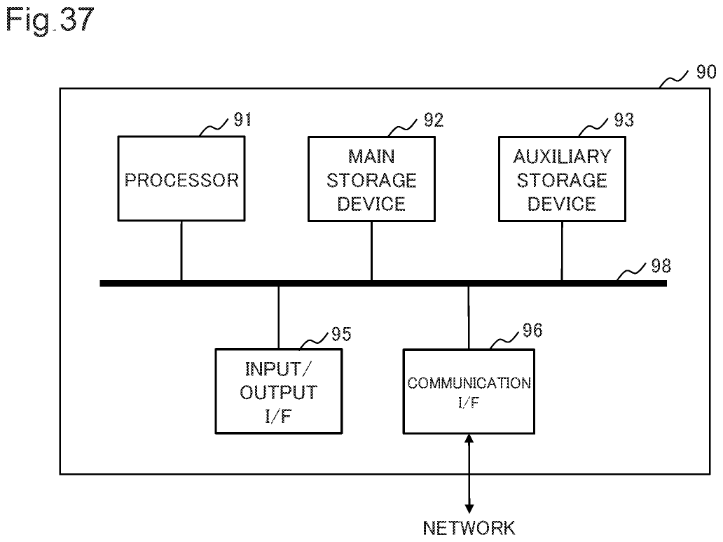

A hardware configuration for executing control and processing according to each example embodiment of the present disclosure will be described using an information processing device 90 of FIG. 37 as an example. The information processing device 90 in FIG. 37 is a configuration example for performing control and a process of each example embodiment, and does not limit the scope of the present disclosure.

As illustrated in FIG. 37, the information processing device 90 includes a processor 91, a main storage device 92, an auxiliary storage device 93, an input/output interface 95, and a communication interface 96. In FIG. 37 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and processing according to each example embodiment.

The main storage device 92 has a region in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magnetoresistive random access memory (MRAM) may be configured and added as the main storage device 92.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input of information and settings. In a case where the touch panel is used as the input device, the display screen of the display device may also serve as the interface of the input device. Data communication between the processor 91 and the input device may be mediated by the input/output interface 95.

The information processing device 90 may be provided with a display device that displays information. In a case where a display device is provided, the information processing device 90 preferably includes a display control device (not illustrated) that controls display of the display device. The display device may be connected to the information processing device 90 via the input/output interface 95.

The information processing device 90 may be provided with a drive device. The drive device mediates reading of data and a program from the recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and processing according to each example embodiment of the present invention. The hardware configuration of FIG. 37 is an example of a hardware configuration for executing control and processing according to each example embodiment, and does not limit the scope of the present invention. A program for causing a computer to execute control and processing according to each example embodiment is also included in the scope of the present invention. A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of each example embodiment may be combined in any manner. The components of each example embodiment may be achieved by software or may be achieved by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

Some or all of the above example embodiments may be described as the following Supplementary Notes, but are not limited to the following.

### (Supplementary Note 1)

A control device including:
a sensing unit that detects, from an image captured by a camera mounted in a drone, a guide light to be used for forming a corridor used by the drone and identifies a position of the detected guide light;
a calculation unit that calculates, according to positions of the drone and the guide light, a predicted arrival position of the drone and a control target position according to a positional relationship between the drone and the guide light, at a control timing subsequent to a timing of capturing the image;
a control condition generation unit that generates a control condition for a motor that drives a propeller of the drone according to the predicted arrival position and the control target position; and
a control condition setting unit that sets the control condition for the motors of the drone.

### (Supplementary Note 2)

The control device according to Supplementary Note 1, wherein
the control condition generation unit
generates the control condition for moving the drone from the predicted arrival position toward the control target position.

### (Supplementary Note 3)

The control device according to Supplementary Note 1 or 2, wherein
the sensing unit
detects a reference guide light to be referred to in utilization of the corridor according to a light emission color of the guide light, and
identifies a position of the detected reference guide light.

### (Supplementary Note 4)

The control device according to Supplementary Note 3, wherein the sensing unit
detects the reference guide light to be referred to in utilization of the corridor according to a plurality of light emission colors at different heights at the guide light, and
identifies a position of the drone in a height direction in the corridor according to a plurality of light emission colors of the detected reference guide light.

### (Supplementary Note 5)

The control device according to Supplementary Note 3 or 4, wherein
the control condition generation unit
generates the control condition for controlling the motor in such a way that the drone moves away from the reference guide light in a case where a distance between the reference guide light and the drone is smaller than a minimum designated distance set for the reference guide light, and
generates the control condition for controlling the motor in such a way that the drone approaches the reference guide light in a case where the distance between the reference guide light and the drone is larger than a maximum designated distance set for the reference guide light.

### (Supplementary Note 6)

The control device according to any one of Supplementary Notes 1 to 5, further including
a charge management unit that monitors an amount of charge of a rechargeable battery mounted on the drone, wherein
the charge management unit
outputs a charge standby signal to the sensing unit when an amount of charge of the rechargeable battery falls below a reference value, wherein
the sensing unit
detects, from the image captured by the camera, a charging station capable of charging the rechargeable battery according to the charge standby signal, and identifies a position of the detected charging station, and wherein
the calculation unit
calculates the position of the charging station as the control target position.

### (Supplementary Note 7)

The control device according to any one of Supplementary Notes 1 to 6, further including
an another device information acquisition unit that acquires position information about an another drone that uses the corridor, wherein
the calculation unit
calculates a distance between the another drone and a host drone, and
sets the control target position in a direction in which the host drone is away from the another drone in a case where the distance between the another drone and the host drone is less than a predetermined distance.

### (Supplementary Note 8)

The control device according to any one of Supplementary Notes 1 to 7, further
including a sound wave signal acquisition unit that acquires a sound wave signal related to a sound wave emitted from the guide light, wherein
the calculation unit
calculates a positional relationship with the guide light using the acquired sound wave signal.

### (Supplementary Note 9)

The control device according to Supplementary Note 8, wherein
the calculation unit
calculates a distance to the guide light according to a frequency of the acquired sound wave signal.

### (Supplementary Note 10)

The control device according to Supplementary Note 8 or 9, wherein
the calculation unit
calculates a distance to the guide light according to sound intensity of the acquired sound wave signal.

### (Supplementary Note 11)

The control device according to any one of Supplementary Notes 1 to 10, further including
a guidance information acquisition unit that acquires guidance information including the control condition generated by a management device that manages the corridor, wherein
the control condition generation unit
outputs the control condition included in the guidance information to a control condition setting unit in response to acquisition of the guidance information.

### (Supplementary Note 12)

A drone including
the control device according to any one of Supplementary Notes 1 to 11,
a motor driven and controlled by the control device,
a propeller that rotates in accordance with driving of the motor,
a transmission information generation unit that generates transmission information including identification information and position information about a host drone,
a communication unit that communicates with a management device that manages a corridor to transmit the transmission information to the management device,
a camera that is imaging controlled by the control device, and
a rechargeable battery.

### (Supplementary Note 13)

The drone according to Supplementary Note 12, further including a microphone that receives a sound wave emitted from a guide light used for forming the corridor.

### (Supplementary Note 14)

A control method executed by a computer, the method including:
detecting, from an image captured by a camera mounted in a drone, a guide light to be used for forming a corridor used by the drone and identifying a position of the detected guide light;
calculating, according to positions of the drone and the guide light, a predicted arrival position of the drone and a control target position according to a positional relationship between the drone and the guide light, at a control timing subsequent to a timing of capturing the image;
generating a control condition for a motor that drives a propeller of the drone according to the predicted arrival position and the control target position; and
setting the control condition for the motors of the drone.

### (Supplementary Note 15)

A program for causing a computer to execute the steps of:
detecting, from an image captured by a camera mounted in a drone, a guide light to be used for forming a corridor used by the drone and identifying a position of the detected guide light;
calculating, according to positions of the drone and the guide light, a predicted arrival position of the drone and a control target position according to a positional relationship between the drone and the guide light, at a control timing subsequent to a timing of capturing the image;
generating a control condition for a motor that drives a propeller of the drone according to the predicted arrival position and the control target position; and
setting the control condition for the motors of the drone.

### REFERENCE SIGNS LIST

10, 20, 30, 40, 50 drone
11, 41 main body
12, 22, 32, 42, 52 propeller
13, 23, 33, 43, 53 control unit
14, 24, 34, 44, 54 motor
15, 25, 35, 45, 55 camera
16, 26, 36, 46, 56 communication unit
17, 27, 37, 47, 57 transmission information generation unit
19, 29, 39, 49, 59 rechargeable battery
120, 420 arm
131, 231, 331, 431 imaging control unit
132, 232, 332, 432, 632 sensing unit
133, 233, 333, 433, 633 calculation unit
134, 234, 334, 434, 634 control condition generation unit
135, 235, 335, 435, 635 control condition setting unit
239 charge management unit
336 another device information acquisition unit
438 sound wave signal acquisition unit
500 management device
501 transmission information acquisition unit
502 position calculation unit
503 guidance position calculation unit
505 guidance information generation unit
507 guidance information output unit

What is claimed is:

1. A control device comprising:
a memory storing instructions; and
a processor connected to the memory and configured to execute the instructions to:
detect, from an image captured by a camera mounted in a drone, a guide light to be used for forming a corridor used by the drone, and to identify a position of the detected guide light;
calculate, according to positions of the drone and the guide light, a predicted arrival position of the drone and a control target position according to a positional relationship between the drone and the guide light, at a control timing subsequent to a timing of capturing the image;
generate a control condition for a motor that drives a propeller of the drone according to the predicted arrival position and the control target position; and
set the control condition for the motors of the drone.

2. The control device according to claim 1, wherein
the processor is configured to execute the instructions to
generate the control condition for moving the drone from the predicted arrival position toward the control target position.

3. The control device according to claim 1, wherein
the processor is configured to execute the instructions to
detect a reference guide light to be referred to in utilization of the corridor according to a light emission color of the guide light, and
identify a position of the detected reference guide light.

4. The control device according to claim 3, wherein
the processor is configured to execute the instructions to
detect the reference guide light to be referred to in utilization of the corridor according to a plurality of light emission colors at different heights at the guide light, and
identify a position of the drone in a height direction in the corridor according to a plurality of light emission colors of the detected reference guide light.

5. The control device according to claim 3, wherein
the processor is configured to execute the instructions to
generate the control condition for controlling the motor in such a way that the drone moves away from the reference guide light in a case where a distance between the reference guide light and the drone is smaller than a minimum designated distance set for the reference guide light, and
generate the control condition for controlling the motor in such a way that the drone approaches the reference guide light in a case where the distance between the reference guide light and the drone is larger than a maximum designated distance set for the reference guide light.

6. The control device according to claim 1, wherein
the processor is configured to execute the instructions to
monitor an amount of charge of a rechargeable battery mounted on the drone,
output a charge standby signal to the sensing means when an amount of charge of the rechargeable battery falls below a reference value,
detect, from the image captured by the camera, a charging station capable of charging the rechargeable battery according to the charge standby signal, and identifies a position of the detected charging station, and
calculate the position of the charging station as the control target position.

7. The control device according to claim 1, wherein
the processor is configured to execute the instructions to
acquire position information about an another drone that uses the corridor,
calculate a distance between the another drone and a host drone, and
set the control target position in a direction in which the host drone is away from the another drone in a case where the distance between the another drone and the host drone is less than a predetermined distance.

8. The control device according to claim 1, wherein
the processor is configured to execute the instructions to
acquire a sound wave signal related to a sound wave emitted from the guide light, and
calculate a positional relationship with the guide light using the acquired sound wave signal.

9. The control device according to claim 8, wherein
the processor is configured to execute the instructions to
calculate a distance to the guide light according to a frequency of the acquired sound wave signal.

10. The control device according to claim 8, wherein
the processor is configured to execute the instructions to
calculate a distance to the guide light according to sound intensity of the acquired sound wave signal.

11. The control device according to claim 1, wherein
the processor is configured to execute the instructions to
acquire guidance information including the control condition generated by a management device that manages the corridor, and
output the control condition included in the guidance information in response to acquisition of the guidance information.

12. A drone comprising:
the control device according to claim 1;
a motor driven and controlled by the control device;
a propeller that rotates in accordance with driving of the motor;
a camera that outputs a captured image to the control device;
a rechargeable battery;
a memory storing instructions; and
a processor connected to the memory and configured to execute the instructions to:
generate transmission information including identification information and position information about a host drone;
communicate with a management device that manages a corridor to transmit the transmission information to the management device.

13. The drone according to claim 12, further comprising
a microphone that receives a sound wave emitted from a guide light used for forming the corridor.

14. A control method executed by a computer, the method comprising:
detecting, from an image captured by a camera mounted in a drone, a guide light to be used for forming a corridor used by the drone and identifying a position of the detected guide light;
calculating, according to positions of the drone and the guide light, a predicted arrival position of the drone and a control target position according to a positional relationship between the drone and the guide light at a control timing subsequent to a timing of capturing the image;
generating a control condition for a motor that drives a propeller of the drone according to the predicted arrival position and the control target position; and
setting the control condition for the motors of the drone.

15. A non-transitory recording medium storing a program for causing a computer to execute the steps of:
detecting, from an image captured by a camera mounted in a drone, a guide light to be used for forming a corridor used by the drone and identifying a position of the detected guide light;
calculating, according to positions of the drone and the guide light, a predicted arrival position of the drone and a control target position according to a positional relationship between the drone and the guide light, at a control timing subsequent to a timing of capturing the image; generating a control condition for a motor that drives a propeller of the drone according to the predicted arrival position and the control target position; and
setting the control condition for the motors of the drone.
